(19) United States
(12) Patent Application Publication
(10) Pub. No.: US 2026/0099754 A1
(43) Pub. Date: Apr. 9, 2026

(54) Neural Network-Based Quantum Error Correction Decoding Method and Apparatus, Device, and Chip

(71) Applicant: TENCENT TECHNOLOGY (SHENZHEN) COMPANY LIMITED, SHENZHEN (CN)

(72) Inventor: Yicong ZHENG, Shenzhen (CN)

(73) Assignee: TENCENT TECHNOLOGY (SHENZHEN) COMPANY LIMITED, SHENZHEN (CN)

(21) Appl. No.: 18/925,709

(22) Filed: Oct. 24, 2024

Related U.S. Application Data
(63) Continuation of application No. PCT/CN2023/108856, filed on Jul. 24, 2023.

(30) Foreign Application Priority Data
Nov. 22, 2022 (CN) 202211468927.9

(51) Int. Cl. G06N 10/70; G06N 10/20; G06N 10/60

(52) U.S. Cl. CPC G06N 10/70; G06N 10/20; G06N 10/60

(57) ABSTRACT

The present disclosure describes neural network-based quantum error correction decoding methods and apparatus, a device, and a chip, relating to the field of artificial intelligence and quantum technologies. One method includes: acquiring error syndrome information obtained from syndrome measurement performed on a quantum circuit; extracting feature information from the error syndrome information by using a neural network decoder; decoding the feature information to obtain a decoding result by using the neural network decoder; and determining error result information of the quantum circuit based on the decoding result.

### RELATED APPLICATIONS

This application is a continuation application of PCT Patent Application No. PCT/CN2023/108856, filed on Jul. 24, 2023, which claims priority to Chinese Patent Application No. 202211468927.9, filed with the China National Intellectual Property Administration on Nov. 22, 2022, both of which are incorporated herein by reference in their entireties.

### FIELD OF THE TECHNOLOGY

Embodiments of the present disclosure relate to the field of artificial intelligence and quantum technologies, and in particular, to a neural network-based quantum error correction decoding method and apparatus, a device, and a chip.

### BACKGROUND OF THE DISCLOSURE

Noise exists in all operational processes in actual quantum computation, including quantum gates and quantum measurement. In other words, even a circuit for quantum error correction itself includes noise.

For fault-tolerant quantum error correction, corresponding error syndrome information is obtained by performing syndrome measurement on a quantum circuit, and then the error syndrome information is decoded to determine a qubit in which an error occurs in the quantum circuit and a corresponding error type. In the related art, some solutions for decoding error syndrome information are provided, such as a decoding solution based on minimum weight perfect matching (MWPM), a decoding solution based on a renormalization group (RG) algorithm, a decoding solution based on cellular automaton (CA), and a decoding solution based on a neural network. At present, the decoding solution based on a neural network still has some limitations in decoding capability.

The present disclosure describes embodiments for decoding quantum error correction based on a neural network, addressing at least one of the problems/issues discussed above, improving decoding performance, shortening decoding time, and/or facilitating implementation of hardware deployment in engineering.

### SUMMARY

Embodiments of the present disclosure provide a neural network-based quantum error correction decoding method and apparatus, a device, and a chip. The technical solutions are as follows.

The present disclosure describes a method for decoding quantum error correction based on a neural network. The method is performed by an electronic device, and includes acquiring error syndrome information obtained from syndrome measurement performed on a quantum circuit; extracting feature information from the error syndrome information by using a neural network decoder; decoding the feature information to obtain a decoding result by using the neural network decoder; and determining error result information of the quantum circuit based on the decoding result.

The present disclosure describes an apparatus for decoding quantum error correction based on a neural network. The apparatus includes a memory storing instructions; and a processor in communication with the memory. When the processor executes the instructions, the processor is configured to cause the apparatus to perform: acquiring error syndrome information obtained from syndrome measurement performed on a quantum circuit; extracting feature information from the error syndrome information by using a neural network decoder; decoding the feature information to obtain a decoding result by using the neural network decoder; and determining error result information of the quantum circuit based on the decoding result.

The present disclosure describes a non-transitory computer-readable storage medium, storing computer-readable instructions. The computer-readable instructions, when executed by a processor, are configured to cause the processor to perform: acquiring error syndrome information obtained from syndrome measurement performed on a quantum circuit; extracting feature information from the error syndrome information by using a neural network decoder; decoding the feature information to obtain a decoding result by using the neural network decoder; and determining error result information of the quantum circuit based on the decoding result.

According to another aspect of embodiments of the present disclosure, a neural network-based quantum error correction decoding method is provided. The method is performed by a control device, and includes: acquiring error syndrome information obtained from syndrome measurement performed on a quantum circuit; using a neural network decoder to extract feature information from the error syndrome information; using the neural network decoder to decode the feature information to obtain a decoding result; and determining error result information of the quantum circuit based on the decoding result.

According to an aspect of embodiments of the present disclosure, a neural network-based quantum error correction decoding apparatus is provided. The apparatus includes:
a syndrome acquiring module, configured to acquire error syndrome information obtained from syndrome measurement performed on a quantum circuit;
a feature extraction module, configured to use a neural network decoder to extract feature information from the error syndrome information,
a feature decoding module, configured to use the neural network decoder to decode the feature information to obtain a decoding result; and
a result determining module, configured to determine error result information of the quantum circuit based on the decoding result.

According to an aspect of embodiments of the present disclosure, a computer device is provided, and includes a processor and a memory. The memory has a computer program stored therein, and the computer program is loaded and executed by the processor to perform the foregoing method.

According to an aspect of embodiments of the present disclosure, a computer-readable storage medium is provided. The computer-readable storage medium has a computer program stored therein, and the computer program is loaded and executed by a processor to implement the foregoing method.

According to an aspect of embodiments of the present disclosure, a computer program product is provided. The computer program product includes a computer program, and the computer program is loaded and executed by a processor to implement the foregoing method.

According to an aspect of embodiments of the present disclosure, a chip is provided. The chip has a neural network decoder deployed thereon, and the neural network decoder is configured to implement the foregoing method.

Embodiments of the present disclosure provide a multi-task learning neural network model-based error correction decoding solution. A neural network decoder extracts corresponding feature information from inputted error syndrome information, decodes the feature information, outputs a decoding result of noise decomposed local information distribution, and then determines error result information based on the decoding result. Compared with a solution in which a plurality of neural network decoders are used, the error result information can be precisely determined with only one single neural network decoder in the solution of the present disclosure, thereby fully improving decoding performance and shortening decoding time while maintaining scalability without increasing algorithm complexity, and facilitating implementation of hardware deployment in engineering.

### BRIEF DESCRIPTION OF THE DRAWINGS

FIG. 1 is a schematic diagram of a rotated surface code according to an embodiment of the present disclosure.

FIG. 2 is a schematic diagram of errors occurring in a surface code according to an embodiment of the present disclosure.

FIG. 3 is a schematic diagram of comparison of decoding performance and decoding time of a plurality of decoding solutions according to an embodiment of the present disclosure.

FIG. 4 is a schematic diagram of an application scenario of a solution according to an embodiment of the present disclosure.

FIG. 5 is a schematic diagram of an error correction decoding process involved in the application scenario shown in FIG. 4.

FIG. 6 is a schematic diagram of simple representations corresponding to syndrome points in a rotated surface code according to an embodiment of the present disclosure.

FIG. 7 is a schematic diagram of a syndrome measurement circuit according to an embodiment of the present disclosure.

FIG. 8 is a schematic diagram of a three-dimensional syndrome distribution according to an embodiment of the present disclosure.

FIG. 9 is a schematic diagram of an architecture for decoding using a plurality of neural network models according to an embodiment of the present disclosure.

FIG. 10 is a flowchart of a neural network-based quantum error correction decoding method according to an embodiment of the present disclosure.

FIG. 11 is a schematic diagram of an architecture of a multi-task learning-based neural network decoder according to an embodiment of the present disclosure.

FIG. 12 is a schematic diagram of a decoding process of a first-type decoder according to an embodiment of the present disclosure.

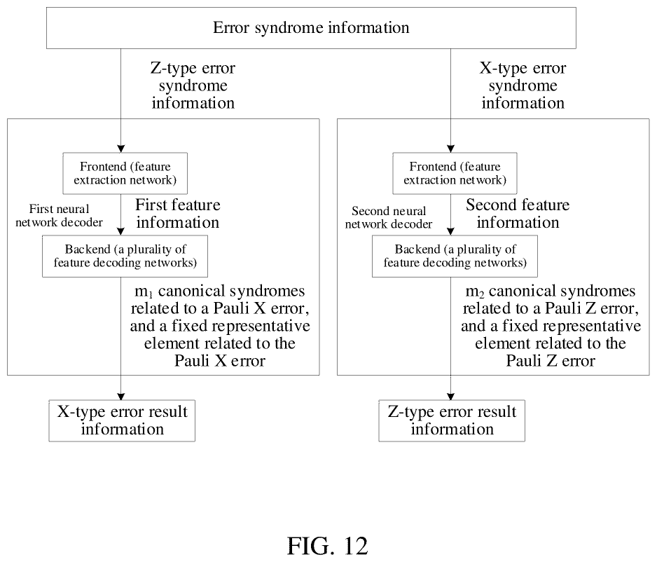

FIG. 13 is a schematic diagram of a decoding process of a second-type decoder according to an embodiment of the present disclosure.

FIG. 14 is a schematic diagram of a decoding process of a second-type decoder according to another embodiment of the present disclosure.

FIG. 15 is a schematic diagram of local feature extraction mapping performed by a feature extraction subnetwork according to an embodiment of the present disclosure.

FIG. 16 is a schematic diagram of associated noise generated by a syndrome measurement circuit according to an embodiment of the present disclosure.

FIG. 17 is a schematic diagram of physical qubit division according to an embodiment of the present disclosure.

FIG. 18 is a schematic diagram of physical qubit division according to another embodiment of the present disclosure.

FIG. 19 is a schematic diagram of a multi-core architecture according to an embodiment of the present disclosure.

FIG. 20 is a schematic diagram of experimental result data corresponding to a first error decomposition manner according to an embodiment of the present disclosure.

FIG. 21 is a schematic diagram of chip deployment according to an embodiment of the present disclosure.

FIG. 22 is a schematic diagram of experimental result data corresponding to a first error decomposition manner according to another embodiment of the present disclosure.

FIG. 23 is a schematic diagram of experimental result data corresponding to a second error decomposition manner according to an embodiment of the present disclosure.

FIG. 24 is a block diagram of a neural network-based quantum error correction decoding apparatus according to an embodiment of the present disclosure.

FIG. 25 is a schematic diagram of a structure of a computer device according to an embodiment of the present disclosure.

### DESCRIPTION OF EMBODIMENTS

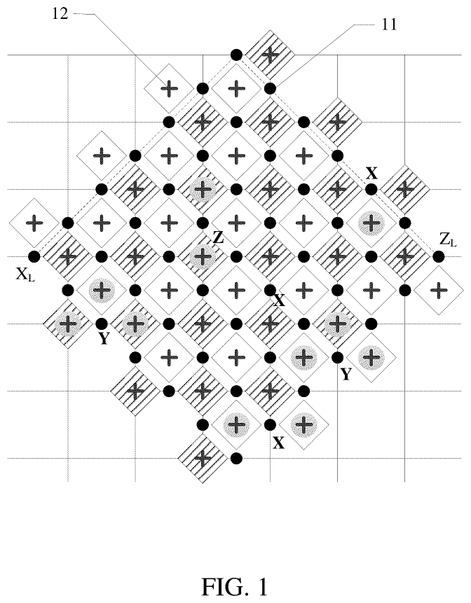

Before embodiments of the present disclosure are described, some terms in the present disclosure are first defined and described.
1. Quantum computation (QC): It is a scheme of using superposition and entanglement properties of quantum states to complete a specific computation task rapidly.
2. Quantum error correction (QEC): It is a scheme of mapping a quantum state into subspace in Hilbert space of a many-body quantum system for encoding. Quantum noise migrates an encoded quantum state to another subspace. Space in which the quantum state is located is continuously observed (syndrome extraction), to assess and correct the quantum noise without disturbing the encoded quantum state, thereby protecting the encoded quantum state from interference by the quantum noise. Specifically, a quantum error correction code [[n,k,d]][[n,k,d]] represents that k logical qubits are encoded in n physical qubits to correct any └(d−1)/2┘└(d−1)/2┘└(d−1)/2┘ errors occurring in any single qubit.
(3) Data quantum state: It is a quantum state configured for storing data qubits of quantum information during quantum computation.
4. Stabilizer generator: It is also referred to as a parity check operator. Occurrence of quantum noise (error) changes eigenvalues of some stabilizer generators, so that quantum error correction can be performed based on the information.
5. Stabilizer group: A stabilizer group is a group generated by stabilizer generators. For example, an Abelian group generated by stabilizer generators is referred to as a stabilizer generator group. If there are k stabilizer generators, a stabilizer group includes 2^{k} elements, and is a commutative group (an Abelian group).
6. Error syndrome: An eigenvalue of a stabilizer generator is 0 when there is no error. When quantum noise occurs, eigenvalues of stabilizer generators (parity check operators) of some error correction codes that are anti-commutative to errors become 1. A bit string includes these 0, 1 syndrome bits is referred to as an error syndrome.
7. Topological quantum error correction code: It is a special type of quantum error correction code. Qubits of such type of error correction code are distributed on a grid array of greater than two dimensions. The grids form a discrete structure of a high-dimensional manifold. In this case, a stabilizer generator of the error correction code is defined on geometrically neighboring and finite qubits, and therefore is geometrically localized and easy to be measured physically. Qubits acted upon by the logical operators of such type of error correction code form a type of topologically non-trivial geometric objects on a manifold of the grid array.
8. Surface code: A surface code is a type of topological quantum error correction code defined on a two-dimensional manifold. A stabilizer generator of the surface code is usually supported by four qubits (supported by two qubits on a boundary), and logic operators are non-trivial chains in the form of strips spanning arrays. A specific two-dimensional structure of the surface code (7*7, including 49 data qubits and 48 auxiliary qubits, a total of 97 physical qubits, which can correct any error that occurs in two qubits) is shown in FIG. 1. Black dots 11 represent data qubits used for quantum computation, and crosses 12 represent the auxiliary qubits. The auxiliary qubits are initially prepared in a |0 [symbol] state or a |+ [symbol] state. Squares filled with slash lines and white represent two different types of stabilizer generators, and are configured for detecting a Z error and an X error, respectively.
9. Surface code scale L: It is a quarter of the circumference of a surface code array. A surface code array L=7 in FIG. 1 includes 97 physical qubits in total, including 49 data qubits and 48 auxiliary qubits.
10. X error and Z error: They are Pauli X and Pauli Z Evolution errors randomly generated on a quantum state of a physical qubit. According to the quantum error correction theory, if an error correction code may correct an X error and a Z error, the error correction code may correct any error that occurs in a single qubit.
11. Fault-tolerant quantum error correction (FTQEC): Noise exists in all operational processes in actual quantum computation, including quantum gates and quantum measurement. In other words, even a circuit for quantum error correction itself includes noise. Error-tolerant quantum error correction is a technique of properly designing an error correction circuit such that an error correction circuit with noise can be used to correct errors and objectives of correcting errors and preventing errors from spreading over time can still be achieved.
12. Fault-tolerant quantum computation (FTQC): During quantum computation, noise may be present in any physical operation, including an operation of a quantum error correction circuit itself and qubit measurement. If it is assumed that there is no noise in a classic operation (such as instruction input or error correction code decoding), the fault-tolerant quantum computation is a technical solution for ensuring effective control and error correction during quantum computation using qubits with noise by properly designing a quantum error correction scheme and performing a quantum gate operation in a specific manner on an encoded logical quantum state.
13. Physical qubit: It is a qubit implemented by using an actual physical device.
14. Logic qubit: It is a mathematical degree of freedom in Hilbert subspace defined by an error correction code. The description of its quantum state is usually a multi-body entangled state, which is generally a two-dimensional subspace of Hilbert space in combination with a plurality of physical qubits. Fault-tolerant quantum computation needs to run on a logical qubit protected by an error correction code.
15: Quantum gate/circuit: It is a quantum gate/circuit acting on a physical qubit.
16. Threshold theorem: For a quantum computation solution that satisfies a requirement of fault-tolerant quantum computation, when error rates of all operations are lower than a specific threshold, a better error correction code, more qubits, and more quantum operations may be used to enable accuracy of computation to arbitrarily approximates to 1, and these additional resource overheads are negligible, compared to exponential acceleration of the quantum computation.
17. Neural network: An artificial neural network is an adaptive non-linear dynamic system formed by a large quantity of simple basic elements, i.e., neurons, connected to each other. A structure and function of each neuron are simple, but a system behavior produced by a combination of a large quantity of neurons is very complex, and in principle, can express any function.
18. Convolutional neural network (CNN): A convolutional neural network is a feed-forward neural network including convolution computation and having a deep structure. A convolutional layer is a core cornerstone of the convolutional neural network. To be specific, a convolution operation is performed on a discrete two-dimensional filter or a discrete three-dimensional filter (also referred to as a convolutional kernel, which is a two-dimensional matrix or a three-dimensional matrix) and a two-dimensional data lattice or a three-dimensional data lattice.
19. Rectified linear unit layer (ReLU layer) uses a rectified linear unit (ReLU) f(x)=max(0,x) as an excitation function of the neural network.
20. A leaky rectified linear unit layer (LeakyReLU Unit) is an ReLU-based activation function, has a small slope for a negative value is very small instead of a flat slope.
21. Error back propagation (BP) algorithm: It is a supervised learning algorithm in an artificial neural network. A BP neural network algorithm may theoretically approximate any function, has a basic structure formed by non-linear change units, and has a strong non-linear mapping capability.
22. Field programmable gate array (FPGA) chip: It is a product from further development based on programmable devices, such as a programmable array logic (PAL) device and a generic array logic (GAL) device. The field programmable gate array chip emerges as a semi-customized circuit in the field of application specific integrated circuits (ASICs), which not only overcome shortcomings of custom circuits, but also overcomes the shortcoming of a limited quantity of gate circuits in conventional programmable devices.
23. Application specific integrated circuit (ASIC): It is an integrated circuit designed and manufactured to meet specific user requirements and needs of specific electronic systems. Using a complex programmable logic device (CPLD) and a FPGA for ASIC design is one of the most popular ways. Both the CPLD and the FPGA have user field programmability and support a boundary scan technology, but the two have their own characteristics in terms of integration, speed, and programming manners.
24. Single flux quantum (SFQ) circuit: It is also referred to as a rapid single flux quantum (RSFQ) circuit, is a circuit formed by Josephson junctions (JJs), and represents “1” and “O” with presence or absence of a magnetic flux quantum. “X” is used to represent a Josephson junction in the circuit. An upper layer and a lower layer are formed by superconductors, and a middle layer is formed by a very thin insulator layer. The single flux quantum circuit may be configured for digital logic computation.
25. Multi-task learning: It is defined as using a same neural network model to complete a plurality of classification tasks simultaneously in the present disclosure. A plurality of neural networks form a large neural network and share a part of the neural network as much as possible to reduce overall computational complexity and space complexity.
26. Canonical Pauli operator: For a specific stabilizer code, a class of equivalent Pauli operators may be expressed by specifying a representative Pauli operator of the Pauli operators. The representative Pauli operator may be referred to as a canonical Pauli operator of the operator type.
27. Adaptive moment estimation (Adam): It is an algorithm for performing first-order gradient optimization on a random target function. The algorithm is based on adaptive low-order moment estimation. The Adam algorithm can be easily implemented and has high computation efficiency and a low memory requirement.

The solution provided in embodiments of the present disclosure relates to an application of an artificial intelligence machine learning technology in the field of quantum technologies, and specifically, to an application of a machine learning technology in a decoding algorithm of a quantum error correction code, which is specifically described in the following embodiments.

Because qubits are susceptible to noise, it is not realistic to implement quantum computation directly on physical qubits with the existing technologies. The development of the quantum error correction code and the fault-tolerant quantum computation technology, in principle, provides a possibility of implementing arbitrary-precision quantum computation on noisy qubits. Generally, measurement of a stabilizer generator of the quantum error correction code (also referred to as parity check of qubits) needs to use a long-distance quantum gate and requires additional qubits to prepare a complex quantum auxiliary state, so as to implement fault-tolerant error correction. Due to a limitation of an existing experimental manner, people are not able to implement a high-precision long-distance quantum gate, or prepare a complex quantum auxiliary state. The use of a surface code as a solution for fault-tolerant quantum error correction and fault-tolerant quantum computation eliminates the needs of using the long-distance quantum gate and preparing the complex quantum auxiliary state, and is therefore considered as a solution very possible to realize a universal fault-tolerant quantum computer using the existing technology.

For an error correction code, when an error occurs, error syndromes may be obtained by parity check. Then, based on these syndromes, it is necessary to use a specific decoding algorithm for the error correction code to determine a location and a type of the error (whether the error is an X error, a Z error, or a combination of both, i.e., a Y error). For the surface code, the error and the error syndromes correspond to specific spatial locations. When there is a syndrome caused by an error, an eigenvalue of an auxiliary qubit at a corresponding location is 1 (which may be regarded as a point particle appearing at the location). When there is no error, the eigenvalue of the auxiliary qubit at the corresponding location is 0. In this case, decoding may be summarized into the following questions. A spatial digital array (two-dimensional or three-dimensional, with a value of 0 or 1) is given. Which qubits are most likely to have errors and specific error types are reasoned based on a specific error model, that is, probability distribution of errors that occur in qubits, and errors are corrected based on the reasoning result.

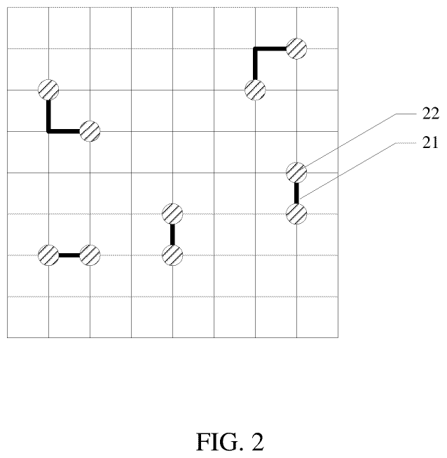

FIG. 2 is a schematic diagram of errors occurring in a surface code. Qubits are on an edge of a two-dimensional array, and auxiliary qubits for measuring error syndromes are on nodes of the two-dimensional array (these syndromes are perfectly measured). Black edges 21 in FIG. 2 represent error chains formed by qubits in which errors occur, and circle portions 22 filled with slash lines represent points at which the value of syndromes caused by the errors are 1. Decoding may be completed provided that chain errors may be determined based on the point syndromes.

As introduced above, corresponding error result information including, for example, a location and a type of an error may be obtained by decoding error syndrome information using a decoding algorithm of an error correction code (also referred to as a decoder). A decoding capability of a decoder may be measured by the following key indicators: decoding algorithm complexity, decoding time, decoding performance, whether the decoder is suitable for real-time error correction, and difficulty in engineering implementation. Decoding algorithm complexity: Indicates total basic computation operations needed to operate the decoding algorithm, and corresponds to computational complexity. Higher complexity indicates a larger computation amount.

Decoding time: The time here is an abstract concept, and is distinct from but closely related to actual decoding time. The decoding time indicates an algorithm depth after full parallelization of the decoding algorithm. The depth determines a minimum time required for actual running of the decoding algorithm, that is, algorithm running time required after maximum parallelization.

Decoding performance: It is measured by a rate of errors occurring in logical qubits after decoding and error correction by using a specific noise model. For the same physical qubit error rate, a lower logical error rate indicates better decoding performance.

Suitability for real-time error correction: The lifetime of a qubit is short (for example, the lifetime of a superconducting qubit is about 150 microseconds under favorable fabrication processes. After a plurality of rounds of syndrome measurement, real-time decoding and error correction are performed based on these syndromes. During decoding, the system is in an idle state, and errors accumulate gradually over time. The theoretical requirement is that an entire error correction process consumes less than 1/1000 to 1/100 of the lifetime of the superconducting qubit. In other words, time rigidity margin of the entire error correction process is about 150 ns to 1,500 ns, otherwise the error rate may exceed an error correction capability of the surface code). A central processing unit (CPU) and a graphics processing unit (GPU) have problems such as uncertainty in memory read and write time, uncertainty in cache hits, and branch jumps. As a result, there may be a long-time delay, and requirements cannot be satisfied. In addition, computing microstructures of the CPU/GPU are not optimized for the decoding algorithm, and therefore has high universality but cannot meet requirements of performance indicators. The present disclosure considers transplanting the decoding algorithm to a specific computing device such as the FPGA or the ASIC. Such type of device is more suitable for running simple operations for parallelization (such as a vector inner product and matrix multiplication), but is not suitable for running complex instructions with conditional determination and jumps.

Difficulty in engineering implementation: It indicates whether it is easy to perform hardware deployment on the decoder in engineering. Theoretical time complexity of a real-time decoding algorithm is low, but actually, control is complicated, or an actual computation amount is still large, and a plurality of computing components are needed to perform parallel computing in cooperation. A delay caused by communication between chips may be even longer than a delay of the computation itself, which is unacceptable in actual real-time decoding. Therefore, an algorithm that is easy to implement in engineering needs to actually reduce the computation amount to reduce a quantity of used computing devices and communication between computing devices (chips). In addition, because most of chip areas of the FPGA/ASIC are used for real-time computation, and an on-chip cache that can be reserved is limited, it is required to avoid preloading excessive data onto the chip. Specifically, for the neural network decoder, a quantity of network parameters that can be used and an increase speed of an error correction code scale need to be restricted, and on-chip memory that can be preset on the chip needs to be easy to read.

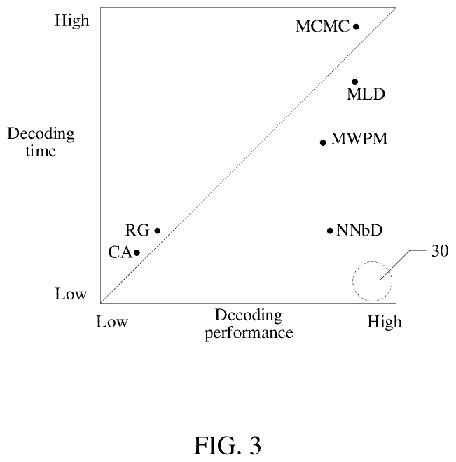

Known quantum error correction decoding solutions include an MWPM-based decoding solution, an RG algorithm-based decoding solution, a CA-based decoding solution, a Monte Carlo Markov chain (MCMC)-based decoding solution, a maximum likelihood decoding (MLD)-based decoding solution, a neural network (NN)-based decoding solution, and the like. FIG. 3 shows a rough comparison of decoding performance and decoding time of the decoding solutions In FIG. 3, a black point corresponding to MWPM is for illustrating decoding performance and decoding time of the MWPM-based decoding solution, a black point corresponding to RG is for illustrating decoding performance and decoding time of the RG algorithm-based decoding solution, a black point corresponding to CA is for illustrating decoding performance and decoding time of the CA-based decoding solution, a black point corresponding to MCMC is for illustrating decoding performance and decoding time of the MCMC-based decoding solution, a black point corresponding to MLD is for illustrating decoding performance and decoding time of the MLD-based decoding solution, and a black point corresponding to NNbD is for illustrating decoding performance and decoding time of the neural network-based decoding solution. In general, it may also be learned from FIG. 3 that the neural network-based decoding solution can achieve good decoding performance for a surface code of a small scale, and requires short decoding time.

The present disclosure provides a multi-task learning-based end-to-end machine learning decoding method. The method greatly improves decoding performance and maintaining scalability without increasing algorithm complexity (computational complexity O(L³), decoding time O(log L)), so as to enable the decoding time and decoding performance to fall within a region 30 in a dashed circle at the lower right corner of FIG. 3. In this case, both the decoding time and the decoding performance are optimal. In addition, the structure is also simpler. To be specific, a quantity of models is reduced from O(L²) to O(1), and there is no need to perform communication between models, thereby facilitating implementation of hardware deployment in engineering.

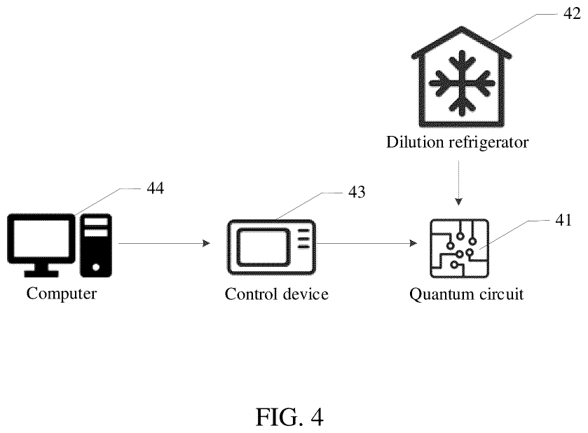

FIG. 4 is a schematic diagram of an application scenario of a solution according to an embodiment of the present disclosure. As shown in FIG. 4, the application scenario may be a superconducting quantum computation platform. The application scenario includes: a quantum circuit 41, a dilution refrigerator 42, a control device 43, and a computer 44.

The quantum circuit 41 is a circuit that acts on a physical qubit. The quantum circuit 41 may be implemented as a quantum chip, such as a superconducting quantum chip near absolute zero. The dilution refrigerator 42 is configured to provide an absolute zero environment for the superconducting quantum chip.

The control device 43 is configured to control the quantum circuit 41. The computer 44 is configured to control the control device 43. For example, a written quantum program is compiled into instructions by software in the computer 44, and the instructions are sent to the control device 43 (such as an electronic/microwave control system). The control device 43 converts the instructions into electronic/microwave control signals and inputs the signals to the dilution refrigerator 42 to control a superconducting qubit at 10 mK. A reading process is the opposite of the foregoing process.

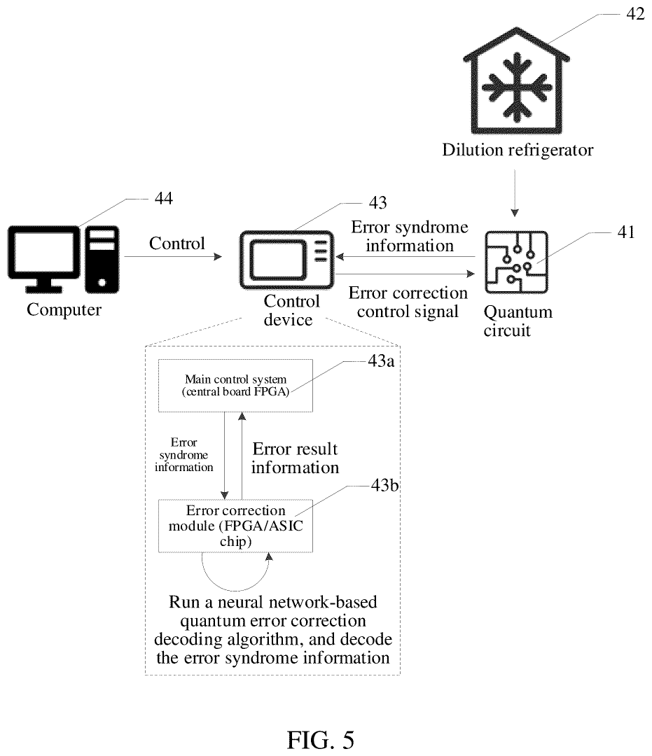

As shown in FIG. 5, the neural network-based quantum error correction decoding method provided in this embodiment of the present disclosure needs to be combined with the control device 43 (for example, the decoding algorithm is integrated into the electronic/microwave control system). After a main control system 43a (such as a central board FPGA) of the control device 43 reads error syndrome information from the quantum circuit 41, the main control system 43a sends an error correction instruction to an error correction module 43b of the control device 43. The error correction instruction includes the error syndrome information of the quantum circuit 41. The error correction module 43b may be an FPGA or ASIC chip. The error correction module 43b runs a neural network-based quantum error correction decoding algorithm, decodes the error syndrome information, converts error result information, obtained through decoding, into an error correction control signal in real time, and sends the error correction control signal to the quantum circuit 41 for error correction.

To facilitate subsequent introduction and description, some basic concepts proposed in the present disclosure are first explained here.

### 1. Canonical Representation of a Pauli Operator

Any Pauli operator P and a generator [symbol] of a stabilizer group of an error correction code [symbol] (in the present disclosure, a rotated surface code is used as an example, and any topological error correction code may be defined in a similar way) are given, the Pauli operator P acting on physical qubits that support the error correction code may be decomposed into:

$$P = L ( P ) T ( S ( P ) )$$

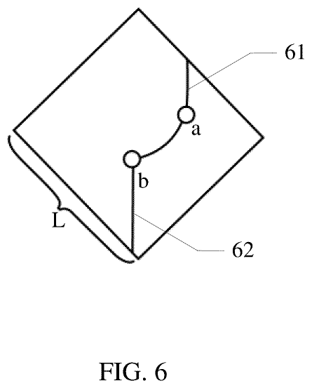

S(P) is a part of a generator (also referred to as a syndrome of the Pauli operator P) in S that is anti-commutative to P. S(P) may be regarded as a bit array formed by 0 and 1. T(S(P)) is a Pauli operator generated by mapping based on the part of the generator. In quantum mechanics, if operator F and operator G satisfy FG=GF, operator F is commutative to operator G. If operator F and operator G satisfy FG=−GF, operator F is anti-commutative to operator G. T(S(P)) and S(P) have a one-to-one correspondence, which is called a simple representation of P. For the rotated surface code, the simple representation may be geometrically defined as a Pauli operator that is the shortest and connects a syndrome to a boundary and that is non-commutative to P. FIG. 6 is a schematic diagram of simple representations corresponding to syndrome points in a rotated surface code. In FIG. 6, dot a represents a syndrome point with a single value of 1, and straight line 61 represents an X-type Pauli operator. The X-type Pauli operator is a Pauli operator that is the shortest and connects syndrome point a to a boundary and that is non-commutative to P. Similarly, dot b represents a syndrome point with a single value of 1, and straight line 62 represents a Z-type Pauli operator. The Z-type Pauli operator is a Pauli operator that is the shortest and connects syndrome point b to a boundary and that is non-commutative to P. Generally, a topological error correction code may have a similar simple representation mapping.

L(P) is a specific operator of an error correction code logic type to which P belongs (once selected, the operator is fixed). If another Pauli operator P′ is considered, similar decomposition is:

$${P}^{′} = L ( {P}^{′} ) T ( S ( {P}^{′} ) )$$

If S(P′)=S(P), and L(P′) and L(P) belong to the same logic type, then P′ and P differ in only one element of a stabilizer group. In other words, P′ and P have equivalent meaning in respect of error correction. Therefore, any Pauli operator P may be defined as:

$${P}_{c} = {L}_{c} ( P ) T ( S ( P ) )$$

L_{c}(P) is a fixed representative element of the logic type to which L(P) belongs, P_{c} is referred to as a canonical representation of P, and L_{c}(P)T(S(P)) is referred to as canonical decomposition of P. All Pauli operators are converted to equivalent canonical representations of the Pauli operators. In this way, unnecessary diversity of a Pauli operator is greatly limited. Especially, when the Pauli operator is selected as an output of a model, difficulty of model training is greatly reduced, thereby increasing a convergence speed of a training process.

### 2. Multi-Model Learning Fault-Tolerant Error Correction

In theory, fault-tolerant error correction of a surface code may be performed after O(L) rounds of syndrome measurement, and all collected syndrome information is summarized and decoded to ensure that an application error correction capability of the error correction code is not affected in a fault-tolerant scenario.

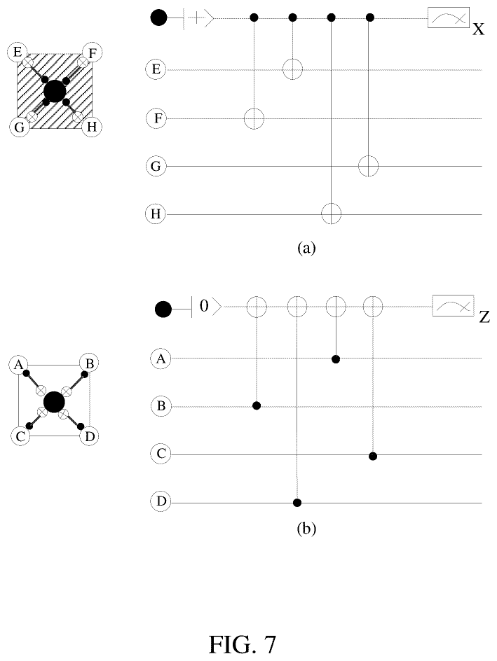

For example, a syndrome measurement circuit may be as shown in FIG. 7. Section (a) of FIG. 7 shows an eigenvalue measurement circuit of a stabilizer generator for detecting a Z error, and section (b) of FIG. 7 shows an eigenvalue measurement circuit of a stabilizer generator for detecting an X errors. In the circuit, a sequence of action of a controlled not (CNOT) gate is very important and cannot be reversed, otherwise conflicts caused by different quantum gates using the same qubit is to be resulted. In this process, noise is caused in all operations, including the controlled not gate, auxiliary state preparation, and final auxiliary state measurement. Because the controlled not gate transfers errors, syndrome measurement of an X-type error and syndrome measurement of a Z-type error intersect each other. An arrangement manner shown in FIG. 7 can minimize error propagation, to make an impact of the error propagation on an error correction capability negligible. The error correction capability is to be greatly lowered if another sequential arrangement is used.

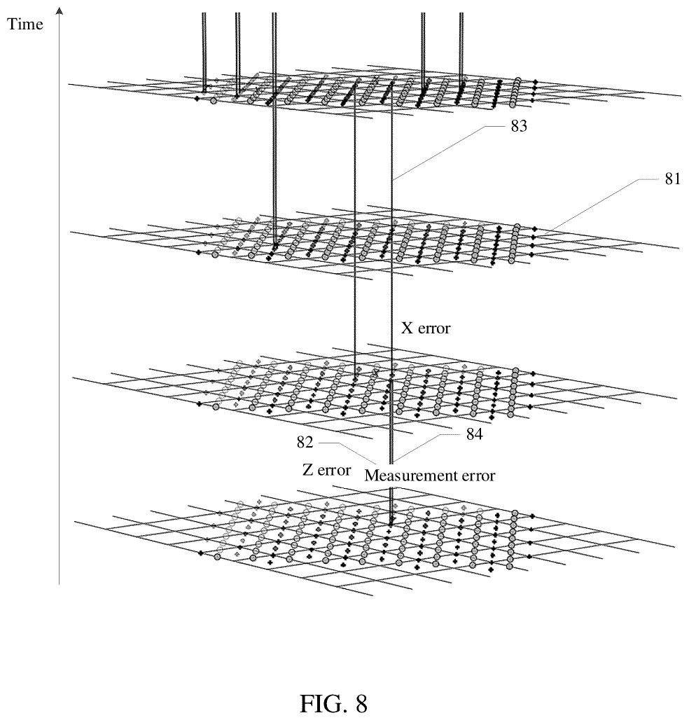

In this case, after a plurality rounds of syndrome measurement, error syndrome information obtained by the syndrome measurement circuit forms a three-dimensional 0-1 array as shown in FIG. 8. FIG. 8 is a schematic diagram of a three-dimensional syndrome distribution with time in a vertical direction. The distribution may be regarded as a three-dimensional data array formed by 0 and 1. In FIG. 8, a total of four slices 81 are included, and each slice 81 represents error syndrome information obtained by one measurement. A line 82 represents a syndrome caused by a Z error, a line 83 represents a syndrome caused by an X error, and a line 84 represents a measurement error.

After O(L) rounds of such syndrome measurement, a mathematical definition of an optimal fault-tolerant (maximum a posterior, MAP) decoder is:

$$\tilde{E} = arg {max}_{E} P r ( E \vert S )$$

$$( The formula is denoted as Formula 1. )$$

S is a three-dimensional data array formed by 0 and 1, and represents error syndrome information. \tilde{E} is a most likely error in a two-dimensional data qubit that may be reasoned based on the measured error syndrome information. An operation corresponding to É is performed on a physical qubit to correct a physical error occurring in the physical qubit. \tilde{E} does not need to be consistent with an actual error Eₚ remained in the physical qubit, provided that a weight wt(\tilde{E}·Eₚ) of a difference between the \tilde{E} and the Eₚ is small enough to ensure that \tilde{E}·Eₚ may be corrected in a next round of error correction. Because a classification result corresponding to each data qubit includes the following four situations: I, X, Y, or Z. I represents no error, X represents an X error, Z represents a Z error, and Y represents a combination of an X error and a Z error. In addition, a quantity of data qubits included in a quantum circuit with an error correction code scale of L is L². Therefore, there are 4^{L}^{²} types of different Pauli operators as possible options of E. Because it is impossible to transverse and calculate all probabilities of E, a decoding problem is a #P-Complete problem in terms of computational complexity. The problem needs to be simplified for efficient decoding. First, it is considered to use a canonical expression of E to represent all equivalent E:

$${E}_{c} = {L}_{c} ( E ) T ( S ( E )$$

In this case, a quantity of Pauli operators to be traversed is reduced to

$$\frac{{4}^{{L}^{2}}}{{2}^{{L}^{2} - 1}} = {2}^{{L}^{2} + 1} .$$

Because for the error correction code, all errors multiplied by an element in a stabilizer group are equivalent, during classification of the errors, these equivalent errors may be combined. Because the stabilizer group includes 2^{L}^{²}⁻¹ elements, only 2^{L}^{²}⁺¹ types of errors need to be traversed. Next, for each Pauli error E, a canonical representation E_{c} representing an equivalent Pauli operator of the Pauli error E is used without distinction.

Further, it is necessary to represent error information and divide the representation information in a divide and conquer manner into different information blocks to reduce traverse complexity. The present disclosure provides two error decomposition manners.

The first manner is to perform canonical decomposition on a canonical representation. Based on one-to-one correspondences between simple errors and syndromes, elements in two sets

$${S}^{X} = \{ {S}_{i}^{X} \vert i = 1 , 2 , … , ( {L}^{2} - 1 ) / 2 \} and {S}^{Z} = \{ {S}_{i}^{Z} \vert i = 1 , 2 , … , ( {L}^{2} - 1 ) / 2 \}$$

of 2^{(L}^{²}^{-1)/}2 syndromes may be used for description, and L_{c} may be determined based on

$${L}_{c}^{X} and {L}_{c}^{Z} .$$

S^{X} and S^{Z} are referred to as canonical syndromes outputted by decoding. S^{X} is used as an example. S^{X} may be decomposed into:

$${S}^{X} = {S}_{1}^{X} ⊔ {S}_{2}^{X} ⊔ … ⊔ {S}_{m}^{X}$$

Each

$${S}_{i}^{X}$$

includes a part of all X-type syndrome bit. The same decomposition is performed for a Z-type syndrome bit. Therefore, a MAP decoding process for the Z-type error is approximated as:

$${\tilde{E}}^{Z} \approx arg {max}_{{L}_{c}^{Z}} P r ( {L}_{c}^{Z} \vert S ) T ( arg {max}_{{S}_{1}^{X}} P r ( {S}_{1}^{X} \vert S ) ⊔ ... ⊔ arg {max}_{{S}_{m}^{X}} P r ( {S}_{m}^{X} \vert S ) )$$

Similar processing may be performed for the X-type error, and a MAP decoding process for the X-type error is approximated as:

$${\tilde{E}}^{Z} \approx arg {max}_{{L}_{c}^{Z}} P r ( {L}_{c}^{Z} \vert S ) T ( arg {max}_{{S}_{1}^{X}} P r ( {S}_{1}^{X} \vert S ) ⊔ ... ⊔ arg {max}_{{S}_{m}^{X}} P r ( {S}_{m}^{X} \vert S ) ) .$$

The second manner is to perform decomposition directly based on distribution of the Pauli errors in the physical qubits. Physical qubits may be divided into different blocks with no intersection or union:

$${𝒫}_{R} : R = {R}_{1} ⊔ {R}_{2} ⊔ … ⊔ {R}_{m}$$

Such division is denoted as [symbol] _{R}, then:

$$E = {E}_{1} ⊗ {E}_{2} ⊗ {E}_{3} ⊗ … ⊗ {E}_{m}$$

Eᵢ is a Pauli operator of E acting on Rᵢ. ⊗ represents a direct product. In this case, approximate simplification may be performed during decoding:

$$\tilde{E} \approx arg {max}_{{E}_{1}} Pr ( {E}_{1} \vert S ) ⊗ arg {max}_{{E}_{2}} Pr ( {E}_{2} \vert S ) ⊗ … ⊗ arg {max}_{{E}_{m}} Pr ( {E}_{m} \vert S ) Pr ( {E}_{i} \vert S ) = {\sum }_{{E}_{R / {R}_{i}}} Pr ( {E}_{i} ⊗ {E}_{R / {R}_{I}} \vert S )$$

is marginal probability distribution of Eᵢ. E_{R\R}_{ᵢ} represents a part of operators of E that acts on qubits outside block i. A value range of i is an integer within [1, m].

Similar to canonical expression decomposition, the errors may be further decomposed into

$${E}_{i}^{X} and {E}_{i}^{Z} ,$$

which are decoded using an approximate MAP separately:

$${\tilde{E}}^{X \vert Z} \approx arg {max}_{{E}_{1}} Pr ( {E}_{1}^{X \vert Z} \vert S ) ⊗ arg {max}_{{E}_{2}} Pr ( {E}_{2}^{X \vert Z} \vert S ) ⊗ … ⊗ arg {max}_{{E}_{m}} Pr ( {E}_{m}^{X \vert Z} \vert S )$$

No matter which manner is used, a selected decomposition/division manner needs to ensure

$$\vert {S}_{i}^{X \vert Z} \vert$$

or |Rᵢ|˜O(1). To be specific, sizes of

$$\vert {S}_{i}^{X \vert Z} \vert$$

and |Rᵢ|˜O(1) have upper limits, and the upper limits are independent of the scale of the error correction code. The decoding performance needs to be improved as much as possible based on the limitations. The reason for this choice is based on intuition that the correlation between syndromes and errors occurring in the physical bits is limited, and a correlation scale does not increase with L.

MWPM decodes an Z(X)-type error based on only an X(Z)-type syndrome. Here, all syndrome bit information may be required to be used simultaneously for decoding of the X error and the Z error. This is because the Z error and the X error are correlated and syndrome bits corresponding to the Z error and the X error are not completely independent. All syndromes are considered together to precisely determine locations of the X error and the Z error, which is not yet exploited by the MWPM or other algorithms.

A purpose of using a machine learning-based manner is to use a neural network to approximate distribution functions

$$Pr ( {L}_{c}^{X \vert Z} \vert S ) , Pr ( {S}_{i}^{X \vert Z} \vert S ) ,$$

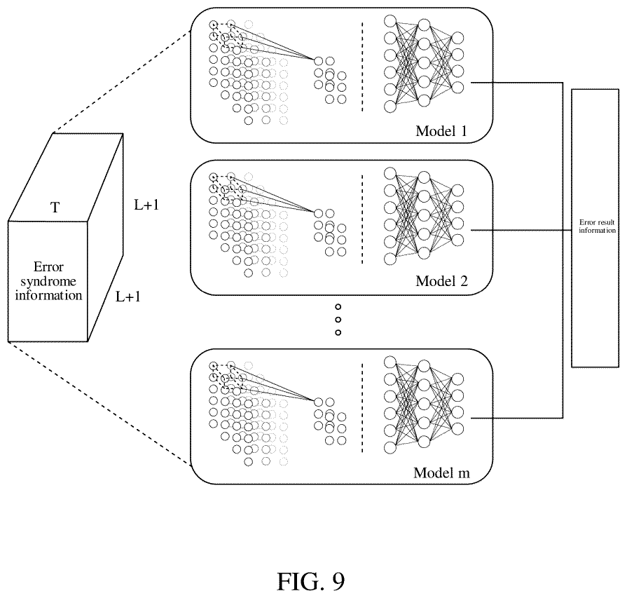

and Pr(Eᵢ|S). Because these functions all have a common input S (a three-dimensional syndrome bit), a direct manner is to use a neural network model to approximate each distribution function, use a Softmax function for normalization at an end of the network to generate corresponding probability distribution, summarize distribution results into error information, and perform correction on the data qubits. An entire decoding process is shown in FIG. 9. m (m is greater than 1) neural network models separately decode the error syndrome information S to obtain m probability distributions, and then error result information is determined based on the m probability distributions. The error result information indicates data qubits in which errors occur and corresponding error types.

An output scale of each network herein has a maximum upper limit. Therefore, a quantity of neural networks is proportional to a quantity L² of physical qubits.

When there is no noise in each syndrome measurement, only one layer of syndrome measurement is needed, and there is no need to reason a simple error part in a canonical expression of an error operator. Therefore, the foregoing Formula 1 may be simplified to:

$$\tilde{E} = arg {max}_{{L}_{c}} Pr ( {L}_{c} \vert S )$$

For a surface code that encodes a single bit, the decoding manner is simplified to a four-category problem, so that only one network is needed to complete decoding. In terms of topology, in the fault-tolerant scenario with measurement noise, a decoding problem cannot be summarized as a similar simple classification problem. Therefore, fault-tolerant decoding using a neural network is much more complicated than a perfect syndrome case.

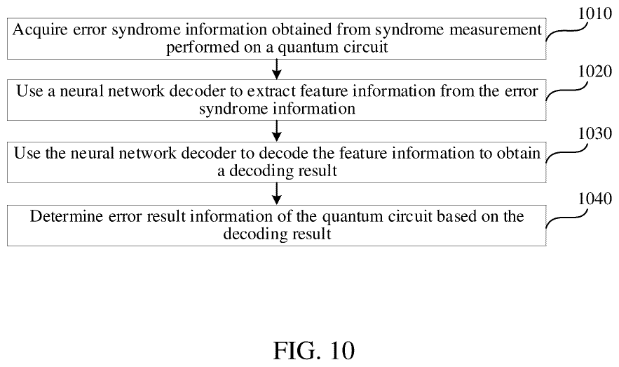

FIG. 10 is a flowchart of a neural network-based quantum error correction decoding method according to an embodiment of the present disclosure. In some implementations, the method is applied to a control device in the application scenario as shown in FIG. 4. In some implementations, the method may be performed by an electronic device, and the electronic device may include a portion or all of the following: a control device, a memory storing instructions, and/or a processor in communication with the memory. The processor is configured, when executing the instructions, to perform a portion or all steps/operations in the methods. The method may include at least one of the following operation 1010 to operation 1040.

Operation 1010: Acquire error syndrome information obtained from syndrome measurement performed on a quantum circuit.

The error syndrome information is a data array including eigenvalues of stabilizer generators of a quantum error correction code.

The quantum error correction code is used to perform error syndrome measurement on the quantum circuit to obtain corresponding error syndrome information. The error syndrome information is a data array including eigenvalues of stabilizer generators of the quantum error correction code. In some embodiments, the error syndrome information is a two-dimensional or three-dimensional data array formed by 0 and 1. For example, an eigenvalue of a stabilizer generator is 0 when there is no error. An eigenvalue of a stabilizer generator is 1 when there is an error.

An example in which the quantum error correction code is a surface code is used. For the surface code, the error and the error syndromes correspond to specific spatial locations. When there is a syndrome caused by an error, an eigenvalue of an auxiliary qubit at a corresponding location is 1 (which may be regarded as a point particle appearing at the location). When there is no error, the eigenvalue of the auxiliary qubit at the corresponding location is 0. Therefore, for the surface code, if an error in an error correction process itself is not considered (in other words, if a measurement process is perfect, and a syndrome is referred to as a perfect syndrome), the error syndrome information may be considered as a two-dimensional data array formed by 0 and 1.

In some embodiments, if a plurality of rounds of syndrome measurement are performed on the quantum circuit, error syndrome information in the form of a two-dimensional data array may be obtained from each round of syndrome measurement, and error syndrome information in the form of a three-dimensional data array may be obtained from the plurality of rounds of syndrome measurement, as shown in FIG. 8.

Operation 1020: Use a neural network decoder to extract feature information from the error syndrome information. In some implementations, the operation 1020 may include extracting feature information from the error syndrome information by using a neural network decoder.

In an exemplary implementation, when the neural network decoder is used to extract feature information from the error syndrome information, a control device may perform feature extraction on the error syndrome information by using a feature extraction network of the neural network decoder to obtain the feature information. The neural network decoder includes the feature extraction network and n feature decoding networks, and n is an integer greater than 1.

The neural network decoder is a machine learning model constructed based on a neural network for decoding error syndrome information. Input data of the neural network decoder is error syndrome information, and output data is error result information corresponding to the error syndrome information.

In this embodiment of the present disclosure, the neural network decoder includes a feature extraction network and a plurality of feature decoding networks. The feature extraction network is configured to perform feature extraction on the error syndrome information to obtain the feature information. The feature information outputted by the feature extraction network is inputted to the plurality of feature decoding networks separately. The plurality of feature decoding networks separately decode the feature information to obtain decoding results respectively corresponding to the plurality of feature decoding networks.

In some embodiments, the feature extraction network may be constructed based on a CNN. In some embodiments, the feature decoding network may be constructed based on a fully connected neural network (FCN). Certainly, the feature extraction network and the feature decoding network are not limited in the present disclosure, and may alternatively be of other network structures.

In FIG. 9, a quantity of models increases linearly with increase of a quantity L² of bits, which results in high computational complexity. Excessive models greatly increase a difficulty of deploying an algorithm on specific hardware. Although these models may run in parallel, the increase of complexity leads to fast increase of hardware resources required, and a large quantity of FPGA or ASIC chips are needed, resulting in a difficulty in system integration. Therefore, an attempt is made to extract as many reusable parts from the O(L²) models as possible to form a frontend, that is, the feature extraction network. A frontend output is fanned out to n˜O(L²) simplified feature decoding networks, such as a feed-forward network (FFN), to generate n probability distributions to complete decoding. These n different feature decoding networks constitute a backend of the model.

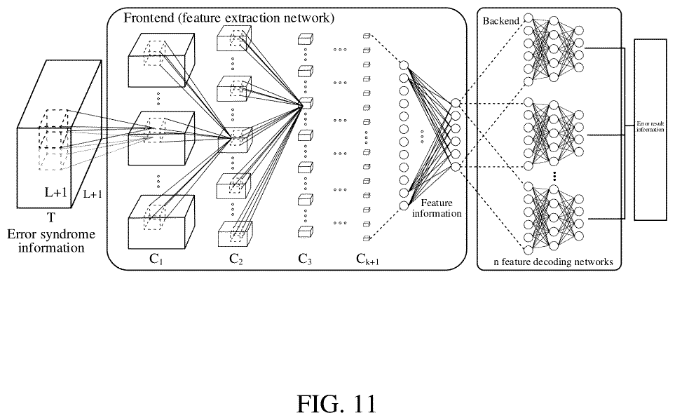

For example, an entire model is as shown in FIG. 11. The frontend is a feature extraction network. The feature extraction network may include a plurality of cascaded feature extraction subnetworks and a feature fusion subnetwork. A function of each feature extraction subnetwork is to extract local feature information in a divide and conquer manner. The feature fusion subnetwork finally summarizes and then compresses all local feature information to finally obtain feature information. The feature extraction subnetworks may be constructed based on a CNN. For example, each feature extraction subnetwork includes one or more convolutional layers. The feature fusion subnetwork may be constructed based on a fully connected network, for example, including one or two fully connected layers.

This is a typical multi-task learning neural network model. Effectiveness of the typical multi-task learning neural network model is based on sufficient features extracted at the frontend to be provided to any feature decoding network at the backend to comprehensively generate precise noise-decomposed local information distributions (such as

$$Pr ( {L}_{c}^{X \vert Z} \vert S ) , Pr ( {S}_{i}^{X \vert Z} \vert S ) ,$$

and Pr(Eᵢ(S)). This is theoretically reasonable. Because the backend may be considered as a local simplified version of an O(2^{L}^{²}⁺¹) global classifier, based on a premise that the frontend may in principle provide information to the global classifier for computation of O(2^{L}^{²}⁺¹) Pauli operator distribution. In addition, the computational complexity of the frontend needs to be acceptable in engineering without affecting decoding performance.

Scales of networks of the frontend and the backend are determined based on a specific situation. According to a current experimental conclusion, a size of the feature decoding network (for example, using the fully connected layer) of the backend may be independent of the error correction code scale L, a quantity of model parameters of the backend is proportional to O(L²), and a computation depth is O(1). Overall computational complexity of the backend is O(L²). Computation complexity of the frontend and complexity analysis of an overall algorithm are described below.

In addition, two error decomposition manners are introduced above. Both error decomposition manners may employ the multi-task learning-based model architecture. An advantage of the first error decomposition manner is that an actual network size is small, but due to a manner of generating training data, performance of a final obtained decoder is limited. The second error decomposition manner allows end-to-end training and employs an X-type syndrome and a Z-type syndrome for decoding to greatly improve decoding performance. In this embodiment of the present disclosure, a neural network decoder that performs training and reasoning in the first error decomposition manner is referred to as a first-type decoder. A neural network decoder that performs training and reasoning in the second error decomposition manner is referred to as a second-type decoder.

In some embodiments, the feature extraction network of the neural network decoder performs feature extraction on the error syndrome information in a divide and conquer manner and through block feature extraction. In other words, each or a part of the feature extraction subnetworks is configured to perform block feature extraction on input data. The block feature extraction means that when extracting feature information, the feature extraction subnetwork divides the input data into a plurality of small blocks, and separately performs feature extraction on each small block. In other words, the block feature extraction means that after the input data is divided into at least two blocks, at least two feature extraction units are used to perform feature extraction processing in parallel on the at least two blocks. The at least two blocks are in one-to-one correspondence with the at least two feature extraction units. Each feature extraction unit is configured to perform feature extraction on a block, and a quantity of blocks is the same as a quantity of feature extraction units. In addition, the at least two blocks perform the feature extraction in parallel, that is, simultaneously, thereby reducing time required for the feature extraction. For example, as shown in FIG. 11, the error syndrome information is a three-dimensional syndrome bit. After the three-dimensional syndrome bit is divided into C₁ blocks, a first feature extraction subnetwork performs feature extraction on the C₁ blocks in parallel to obtain C₂ blocks. Similarly, a second feature extraction subnetwork performs feature extraction in parallel on the C₂ blocks to obtain C₃ blocks. By analogy, a k^{th} feature extraction subnetwork performs feature extraction in parallel on Cₖ blocks to obtain Cₖ₊₁ blocks. Finally, the feature fusion subnetwork performs fusion and compression processing on the Cₖ₊₁ blocks to obtain the feature information, which is used as an input of the backend.

Operation 1030: Use the neural network decoder to decode the feature information to obtain a decoding result. In some implementations, the operation 1030 may include decoding the feature information to obtain a decoding result by using the neural network decoder.

In an exemplary implementation, when the neural network decoder includes the feature extraction network and the n feature decoding networks, the control device may use the n feature decoding networks to separately decode the feature information to obtain decoding results respectively corresponding to the n feature decoding networks. The n feature decoding networks are trained in a multi-task learning manner to be enabled to generate different decoding results.

For the first-type decoder, operation 1030 may include:
using n₁ feature decoding networks to separately decode the feature information to obtain decoding results respectively corresponding to the n₁ feature decoding networks, for an i^{th} feature decoding network of the n₁ feature decoding networks, a decoding result corresponding to the i^{th} feature decoding network including: an i^{th} canonical syndrome related to a target error type, i being a positive integer less than or equal to n₁, and the canonical syndrome being a canonical decomposition result of the error syndrome information; and
using n₂ feature decoding networks to separately decode the feature information to obtain decoding results respectively corresponding to the n₂ feature decoding networks, for a j^{th} feature decoding network of the n₂ feature decoding networks, a decoding result corresponding to the j^{th} feature decoding network including: a fixed representative element related to the target error type, j being a positive integer less than or equal to n₂, a sum of n₁ and n₂ being equal to n, and both n₁ and n₂ being positive integers.

In some embodiments, the target error type includes the Pauli X error and the Pauli Z error, m₁ is equal to a sum of m₁ and m₂, both m₁ and m₂ are positive integers, and n₂ is equal to 2;
m₁ feature decoding networks of the n₁ feature decoding networks are configured to separately decode the feature information to obtain m₁ canonical syndromes related to the Pauli X error;
m₂ feature decoding networks of the n₁ feature decoding networks are configured to separately decode the feature information to obtain m₂ canonical syndromes related to the Pauli Z error;
one of the n₂ feature decoding networks is configured to decode the feature information to obtain a fixed representative element related to the Pauli X error; and
another one of the n₂ feature decoding networks is configured to decode the feature information to obtain a fixed representative element related to the Pauli Z error.

In some embodiments, values of m₁ and m₂ may be the same or different. In some embodiments, the error syndrome information includes Z-type syndrome information and X-type syndrome information. The Z-type syndrome information is decoded to obtain X-type error result information. The X-type error result information indicates a qubit in which the Pauli X error occurs in the quantum circuit. The X-type syndrome information is decoded to obtain Z-type error result information. The Z-type error result information indicates a qubit in which the Pauli Z error occurs in the quantum circuit.

In some embodiments, the m₁ canonical syndromes related to the Pauli X error can be expressed as

$${S}_{1}^{z} , {S}_{2}^{z} , … , {S}_{m 1}^{z} .$$

### Each

$${S}_{i}^{z}$$

includes a part of Z-type syndrome bits, and is configured for decoding to determine an X-type error. The m₂ canonical syndromes related to the Pauli X error can be expressed as

$${S}_{1}^{X} , {S}_{2}^{X} , … , {S}_{m 2}^{X} .$$

### Each

$${S}_{i}^{X}$$

includes a part of X-type syndrome bits, and is configured for decoding to determine an Z-type error. The fixed representative element related to the Pauli X error may be expressed as

$${L}_{c}^{X} .$$

The fixed representative element related to the Z error may be expressed as

$${L}_{c}^{Z} .$$

For the second-type decoder, operation 1040 may include: determining the error result information based on Pauli operators respectively acting on the n blocks, that is, determining the error result information É based on E₁, E₂, . . . , and Eₙ. For details about a principle for determining \tilde{E}, refer to descriptions in the foregoing embodiments.

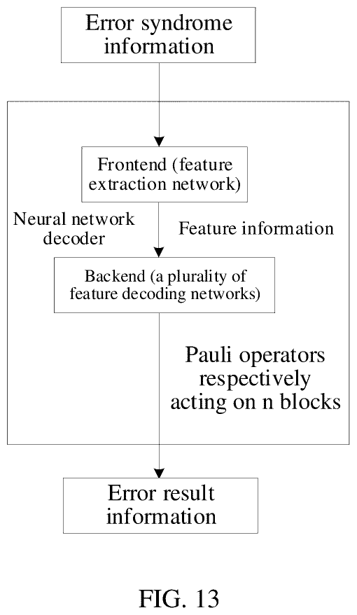

In some embodiments, as shown in FIG. 13, for the second-type decoder, the error result information indicates a qubit in which a Pauli X error occurs and a qubit in which a Pauli Z error occurs in a quantum circuit. In other words, the error syndrome information is not distinguished using X-type error syndrome information and Z-type error syndrome information, and all syndrome bits are jointly used to decode an X error and a Z error. Correspondingly, the decoding results is not distinguished using X-type error result information and Z-type error result information, and error result information including an X-type error and a Z-type error is directly obtained through decoding. Because the X error and Z error are correlated to each other, locations of the X error and Z error can be determined precisely in the foregoing manner by considering all syndrome bits together. According the following experimental data, decoding performance is greatly improved by doing so. In this case, only one neural network decoder is needed to complete decoding of the error syndrome information to obtain the error result information.

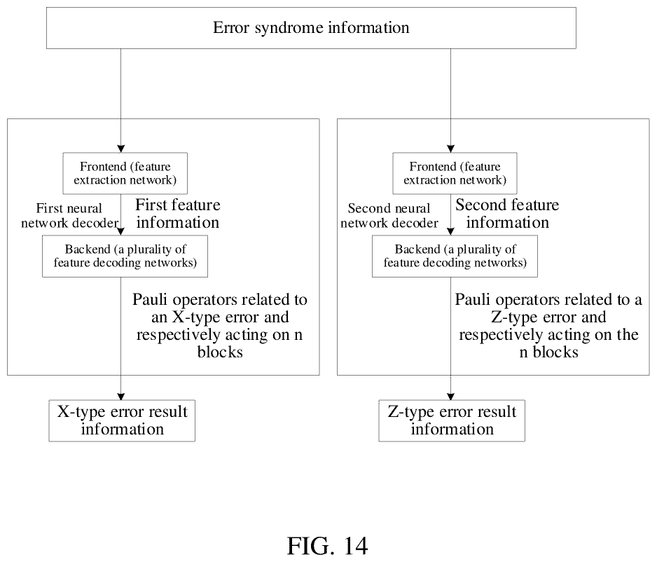

In some embodiments, for the second-type decoder, two neural network decoders, denoted as a first neural network decoder and a second neural network decoder, may also be used. As shown in FIG. 14, inputs of both the first neural network decoder and the second neural network decoder are error syndrome information. The error syndrome information is not distinguished using X-type error syndrome information and Z-type error syndrome information, and all syndrome bits are jointly used to decode the X error and the Z error. A feature extraction network of the first neural network decoder perform feature extraction on the error syndrome information to obtain first feature information, and n feature decoding networks of the first neural network decoder separately decode the first feature information to obtain first decoding results respectively corresponding to the n feature decoding networks. A first decoding result corresponding to a k^{th} feature decoding network includes a Pauli operator related to an X-type error acting on a k^{th} block. X-type error result information is determined based on the first decoding results respectively corresponding to the n feature decoding networks. The X-type error result information indicates a qubit in which a Pauli X error occurs in the quantum circuit. In addition, a feature extraction network of the second neural network decoder performs feature extraction on the error syndrome information to obtain second feature information, and n feature decoding networks of the second neural network decoder separately decode the second feature information to obtain second decoding results respectively corresponding to the n feature decoding networks. A second decoding result corresponding to a k^{th} feature decoding network includes a Pauli operator related to a Z-type error acting on a k^{th} block. Z-type error result information is determined based on the second decoding results respectively corresponding to the n feature decoding networks. The Z-type error result information indicates a qubit in which a Pauli Z error occurs in the quantum circuit. The first neural network decoder and the second neural network decoder may be trained in the multi-task learning manner described above, and a quantity of feature decoding networks included in the first neural network decoder may be the same as or different from that in the second neural network decoder, which is not limited in the present disclosure.

An output type of the neural network decoder is not limited in embodiments of the present disclosure. In one possible implementation, a physical-level output is used. A physical-level output model directly generates information about a specific qubit in which an error occurs, i.e., information about a type of an error that occurs in a qubit. In another possible implementation, a logic-level output is used. A logic-level output model outputs a logical error type of a specific error undergone specific mapping. Then, that an equivalent error that specifically occurs in a qubit may be reasoned based on the logical error type (the reasoned error may not be the same as an original error, but has the same effect, which is an error degeneracy phenomenon specific to a quantum error correction code). In some embodiments, to reduce complexity of the neural network decoder and further reduce decoding time, the neural network decoder may use the logic-level output.

In some embodiments, a measurement and collection process of new error syndrome information is performed in parallel with decoding of the acquired error syndrome information by the neural network decoder. The syndrome measurement and the decoding are performed in parallel without needing to starting decoding until O(L) syndrome measurements end. When there are sufficient syndrome bits to complete minimum-unit computation (such as a single convolutional operation), corresponding computation may be started. In this case, the decoding may be started during subsequent syndrome measurement, so that the syndrome measurement and the decoding are performed in parallel. In this way, overall delay from the end of a last round of syndrome measurement to the completion of error correction is reduced. Shorter delay is preferred to avoid error accumulation during the error correction.

In some embodiments, a feature extraction network and n feature decoding networks included in the neural network decoder are deployed on the same chip. In some embodiments, the chip may be an FPGA chip or an ASIC chip. In some embodiments, when two neural network decoders are needed in some embodiments, the two neural network decoders may be deployed on the same chip or on two chips, which is not limited in the present disclosure.

In conclusion, embodiments of the present disclosure provide a multi-task learning neural network model-based error correction decoding solution. A neural network decoder extracts corresponding feature information from inputted error syndrome information, decodes the feature information, outputs a decoding result of noise decomposed local information distribution, and then determines error result information based on the decoding result. Compared with a solution in which a plurality of neural network decoders are used, the error result information can be precisely determined with only one single neural network decoder in the solution of the present disclosure, thereby fully improving decoding performance and shortening decoding time while maintaining scalability without increasing algorithm complexity, and facilitating implementation of hardware deployment in engineering. For example, in the foregoing embodiment, the neural network decoder is designed to include a feature extraction network and a plurality of feature decoding networks. The feature extraction network extracts corresponding feature information from inputted error syndrome information, and the feature information is used as inputs of the plurality of feature decoding networks. The plurality of feature decoding networks output noise-decomposed local information distribution, and then error result information is determined based on decoding results of the plurality of feature decoding networks. Compared with a solution in which a plurality of neural network decoders are used, the solution fully improves decoding performance and shortens decoding time and maintaining scalability without increasing algorithm complexity, and facilitating implementation of hardware deployment in engineering.

In addition, for the foregoing second-type decoder, a manner of directly performing decomposition based on Pauli error distribution in a physical qubit allows end-to-end reasoning and training. In addition, because the X error and Z error are correlated to each other, an X-type syndrome and a Z-type syndrome are used to perform decoding. Locations of the X error and Z error can be determined precisely by considering all syndrome bits together, thereby greatly improving decoding performance.

In some embodiments, for the feature extraction network of the neural network decoder, the present disclosure proposes to use local feature extraction mapping (LFEM) to lower computational complexity.

In addition to complexity of an output end due to measurement noise (solved through multi-task learning), another complexity of the neural network decoder is due to its complex training and reasoning. Embodiments of the present disclosure provide the following solutions. An error correction code of a large scale is regarded as a plurality of error correction codes of a small scale (which may be referred to as “small error correction codes”). After local “decoding” of the “small error correction codes” is performed, obtained information is summarized and “decoded” at a higher level. This process may be recursive until final decoding information is an error to be corrected. Decoding of the “small error correction codes” in a specific region at each layer may be referred to as LFEM.

In some embodiments, the feature extraction network includes a plurality of cascaded feature extraction subnetworks, where input data of a first feature extraction subnetwork includes the error syndrome information, input data of an s^{th} feature extraction subnetwork includes output data of an (s−1)^{th} feature extraction subnetwork, output data of a last feature extraction subnetwork includes the feature information, and s is an integer greater than 1.

For a target feature extraction subnetwork of the plurality of cascaded feature extraction subnetworks, input data of the target feature extraction subnetwork is divided into a plurality of input data blocks of the same scale. The target feature extraction subnetwork may be any one of the plurality of cascaded feature extraction subnetworks. The target feature extraction subnetwork is configured to perform a plurality of local feature extraction mappings on the plurality of input data blocks to obtain a plurality of sets of mapping output data. Each local feature extraction mapping is configured to perform mapping on regions at a same location in the plurality of input data blocks to obtain a set of mapping output data; and the plurality of local feature extraction mappings are configured to perform mapping on regions at different locations in the plurality of input data blocks to obtain the plurality of sets of mapping output data. The target feature extraction subnetwork is further configured to obtain output data of the target feature extraction subnetwork based on the plurality of sets of mapping output data.

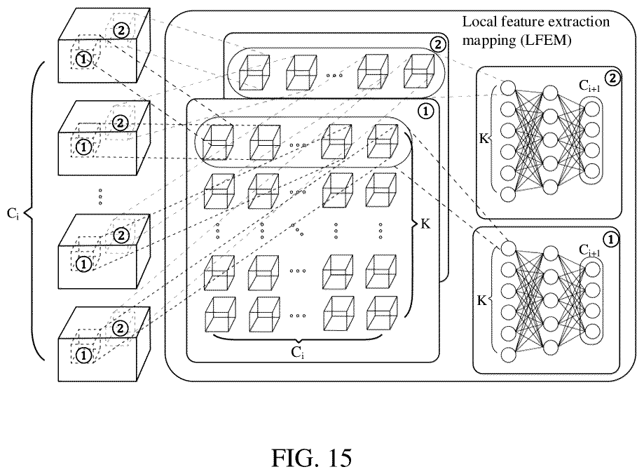

FIG. 15 is a schematic diagram of local feature extraction mapping performed by a feature extraction subnetwork. FIG. 15 shows a process of performing LFEM on two regions (distinguished by symbols \textcircled{1} and \textcircled{2} in the figure) at different locations. One single LFEM acts on regions at the same location in Cᵢ input data blocks. Different LFEMs act on regions at different locations in the Cᵢ input data blocks. The figure shows two regions at different locations \textcircled{1} and \textcircled{2}.

In some embodiments, the regions at the different locations overlap each other. The overlap between regions at the different locations means that there are overlapping data between the regions at the different locations. In addition, there may be overlap in some or all directions in a three-dimensional direction. To reduce computational complexity, overlap between the “small error correction codes” of each layer is small in the three-dimensional direction. In this case, a quantity of layers of local “error correction” increases by O(log L). The overlap between the regions at the different locations is set to improve a decoding effect, because cross-validation may be performed on the same part of information after being acted by two LFEM to improve decoding performance. However, it is not suitable for excessive overlap to generate additional computational complexity. Parameters of networks related to the different LFEM are the same, but input regions are different.

In some embodiments, a target feature extraction subnetwork includes at least one convolutional layer and at least one fully connected layer. The at least one convolutional layer is configured to perform the plurality of local feature extraction mappings on the plurality of input data blocks to obtain the plurality of sets of mapping output data. The at least one fully connected layer is configured to obtain the output data of the target feature extraction subnetwork based on the plurality of sets of mapping output data.

When the feature extraction subnetwork is constructed, a simplest way is to use a single-layer 3D CNN, but an expressive capability of the neural network is limited, and decoding performance is greatly affected when the error correction code scale is large. Therefore, it is considered that after acting on the same region of all input three-dimensional information blocks (Cᵢ in total) (dashed boxes marked with the same symbol in FIG. 15), 3D CNN kernels are connected to an FFN for further information integration and compression. The FFN can include fully connected layers with different layers, and in practice, a maximum quantity of layers may be limited to 2.

Overall parameter complexity analysis: When hardware performs real-time decoding, it is necessary to pre-configure parameters on a computing device (such as an FPGA or an ASIC). A quantity of parameters determines an eventually occupied volume of an on-chip memory. The quantity of parameters of each feature extraction subnetwork is determined based on a structure of the LFEM. The quantity of parameters of the 3D CNN in an i^{th} layer is KᵢCᵢM³. M=max{kᵢ} is a size of a maximum-scale convolutional kernel edge. A parameter of the FFN is Cᵢ₊₁Kᵢ. If Cᵢ, Cᵢ₊₁, Kᵢ˜O(1), a total quantity of parameters of a frontend is:

$${\sum }_{i = 1}^{{log}_{k} L} {K}_{i} {C}_{i} {M}^{3} + {K}_{i} {C}_{i + 1} ∼ O ( log L )$$

A quantity of parameters of a backend is O(L²), and therefore, the total quantity of parameters is O(L²). The constant hidden under O is usually large. Therefore, when L is small, the frontend may actually occupy more parameters than the backend. Gradual growth and actual parameters of a real model obtained through testing are acceptable in actual engineering.

Depth (or computation time) of the overall algorithm: This part is determined by performing multiplication and addition in a fastest way. All multiplication operations of 3D CNN and FFN parts (where a quantity of FFN layers is less than or equal to 2) in the feature extraction subnetwork may be completed in as fast as O(1) hours. O(log Cᵢ)˜O(1) operations are required for accumulation after the multiplication, so that the total computation time of one single feature extraction subnetwork is O(1). There are O(log L) feature extraction subnetworks in total. Therefore, the total computation time (depth) of the frontend is O(log L). Complete parallelization may be implemented within the backend total computation time, sizes of O(L²) feature decoding networks at the backend are independent of L, a quantity of layers is O(1), computation time for multiplication is O(1), and computation time for accumulation is O(log C)˜O(1). Therefore, the depth of the overall algorithm is O(log L). The algorithm time is a shortest computation time that can be achieved theoretically under a condition of sufficient computation resources.

Analysis of overall operation complexity: The input three-dimensional feature block of each layer is an output feature block of a previous layer. It is assumed that a quantity of input feature blocks in an i^{th} layer is Cᵢ, and a quantity of output feature blocks is Cᵢ₊₁. If Cᵢ, Cᵢ₊₁, Kᵢ˜O(1), an input scale of each LFEM is O(1), a quantity of times the LFEM needs to act in the layer is

$$O ( {C}_{i} {{K}_{i} ( \frac{L}{{k}^{i}} )}^{3} ) .$$

k=min {kᵢ}˜O(1) is a smallest convolution kernel of the entire network. An amount of frontend multiplication computation that may be obtained is:

$$∼ {\sum }_{i = 1}^{{log}_{k} L} {C}_{i} {{K}_{i} ( \frac{L}{{k}^{i}} )}^{3} {k}^{3} + {K}_{i} {{C}_{i + 1} ( \frac{L}{{k}^{i}} )}^{3} ∼ O ( {L}^{3} )$$

Because the amount of the multiplication computation is dominant, and an amount of backend multiplication computation is ˜O(L²), so that complexity of the entire decoding process may be controlled at O(L³). If multi-task learning is not used, the computational complexity of the entire decoding process increases to O(L²L³)=O(L⁵), which is unacceptable in actual engineering.

In addition, there are many different types of excitation layers of the neural network. For convenience of hardware deployment, the present disclosure only uses two of the hardware, that is, ReLU and LeakyReLU. The LeakyReLU is defined as:

$$f ( x ) = \{ \begin{matrix}x & if x > 0 \\ ax & otherwise\end{matrix}$$

a<0 is selected, and

$$\vert a \vert = \frac{1}{{2}^{l}} , l ∈ {N}^{+}$$

is required, and N⁺ represents a set of positive integers. An advantage is that computation of the excitation layer only needs to determine a sign bit and a finite bit for right shift, which greatly simplifies a computation implementation. The simulation shows that the LeakyReLU is enough to provide a quite good effect.

In some embodiments, a training process of a neural network decoder is as follows:
1. acquiring sample error syndrome information and sample error result information corresponding to the sample error syndrome information;
2. using a to-be-trained neural network decoder to obtain, based on the sample error syndrome information, predicted decoding results respectively corresponding to the n feature decoding networks;
3. determining, based on the predicted decoding results respectively corresponding to the n feature decoding networks and label decoding results that respectively correspond to the n feature decoding networks and that is determined based on the sample error result information, loss function values respectively corresponding to the n feature decoding networks;
4. determining a total loss function value based on the loss function values respectively corresponding to the n feature decoding networks; and
5. adjusting a parameter of the to-be-trained neural network decoder based on the total loss function value to obtain a trained neural network decoder.

A model network structure is set and the model needs to be trained. Because there are many distribution functions to be learned at an output end, outputs of the n feature decoding networks are trained by using a cross entropy loss function. In addition, when input-output training data is generated, the input end is designated as a randomly generated syndrome (which may be a single X or Z syndrome, or may include the two syndromes simultaneously), and the output end is a corresponding output of the syndrome, and one hot coding is performed. An input of the same syndrome may correspond to different outputs. Such diversity of the output end enables the model to finally learn output probability distribution based on a specific input syndrome during the training process.

For the i^{th} feature decoding network of the n feature decoding network, a loss function value corresponding to the i^{th} feature decoding networks are determined based on a predicted decoding result corresponding to the i^{th} feature decoding network and a label decoding result that corresponds to the i^{th} feature decoding network and that is determined based on the sample error result information. The loss function value corresponding to the i^{th} feature decoding network is configured to measure a similarity between the predicted decoding result corresponding to the i^{th} feature decoding network and the label decoding result corresponding to the i^{th} feature decoding network. The label decoding result corresponding to the i^{th} feature decoding network is a preset output label of the i^{th} feature decoding network, and may alternatively be understood as an expected output result. A goal of training the i^{th} feature decoding network is to enable a corresponding predicted decoding result as the same as or close to the label decoding result as possible. For each of the n feature decoding networks, the loss function value corresponding to the feature decoding network may be determined in the foregoing manner.

After the loss function values respectively corresponding to the n feature decoding networks are obtained, weighted summation may be performed on the loss function values respectively corresponding to the n feature decoding networks to obtain the total loss function value. The total loss function value is configured to represent performance of the entire neural network decoder. In addition, weight values corresponding to the feature decoding networks may be the same or different, which is not limited in the present disclosure.

Then, a gradient descent method may be used to minimize the total loss function value, and a parameter adjustment gradient of the neural network decoder is obtained by computation. Parameter adjustment is performed on the to-be-trained neural network decoder based on the parameter adjustment gradient to obtain a trained neural network decoder. The parameters of the neural network decoder include weight parameters of all neural networks included in the neural network decoder.

If error canonical decomposition is used as an output (a first decomposition manner), it is necessary to ensure a one-to-one correspondence between an input and an output in training data. If an input syndrome corresponds to a plurality of output estimation syndromes S^{X|Z}, a single-input and multi-output situation causes local canonical syndrome reasoning inconsistency with a O(1) probability because correlation between reasoning syndromes is cut off. Different from noise on a physical bits, once the canonical syndrome reasoning is inconsistent, decoding fails immediately with a O(1) probability. If training data is generated directly from simulation data, there is no guarantee that the inputs correspond to the outputs one by one. Therefore, when canonical representation decomposition is used, a third-party decoder is needed to generate a one-to-one corresponding input and output. A natural choice is to use an MWPM decoder to generate a single output based on a syndrome generated by simulation. It may be considered that a good and complex known decoder is used without considering computational complexity. In this case, two types of syndromes may be separated and used to decode two types of errors (because this is an input-output mode generated by the MWPM), and overall computational complexity can be compressed with losing less computational complexity.

For a second decomposition manner, a canonical representation of original error data generated by simulation is directly used as an output label of multi-task learning, and both an X-type syndrome and an Z-type syndrome are used as the model input. This allows the same input syndrome to correspond to a plurality of output errors in a training set. This is because different results obtained by reasoning based on physical bit distribution only causes a local residual physical bit error at most, and does not constitute a logical error. In addition, learning physical error distribution, rather than just maximum likelihood learning can obtain good decoding performance.

In an actual training process, a classic Adam algorithm may be used for the two decomposition manners, and a batch size may be above 1000. Considering that the loss function corresponding to the feature decoding network is lossᵢ (i representing the i^{th} feature decoding network, taking a positive integer), all the loss functions may be added to generate a total loss function:

$$Loss = {\sum }_{i} {α}_{i} * {loss}_{i}$$

Loss is the total loss function of the neural network decoder. lossᵢ is the loss function corresponding to the i^{th} feature decoding network. αᵢ is the weight value of the loss function corresponding to the i^{th} feature decoding network. In addition, the Adam algorithm is used to perform gradient descent multi-task joint learning on the loss function Loss. In actual situation, all αᵢ may be set to 1, certainly, may alternatively be set to another value. In each training epoch, a learning rate is gradually decreased, or is improved first and then decreased. It may be handled flexibly based on the actual situation.

In some embodiments, division of the blocks is related to correlation between errors, and the qubits included in the same block are prone to produce correlated errors.

The qubits included in the same block being prone to generate correlated errors means that a probability of correlated errors occurring in qubits included in a same block is greater than a probability of correlated errors occurring in qubits included in different blocks.

For example, a probability of correlated Pauli X error or Pauli Z errors occurring in qubits included in the same block is greater than a probability of correlated Pauli X error or Pauli Z errors occurring in qubits included in different blocks.

As described above, if the second decomposition manner is used, a model may be trained by using the original error generated in a simulation process instead of indirect error data generated by another decoder. As described above, to reduce complexity of an error correction algorithm on a large scale, physical qubits may be divided:

$$R = {R}_{1} ⊔ {R}_{2} … ⊔ {R}_{m}$$

In addition, in multi-task learning, only errors

$${E}_{i}^{X} and {E}_{i}^{Z}$$

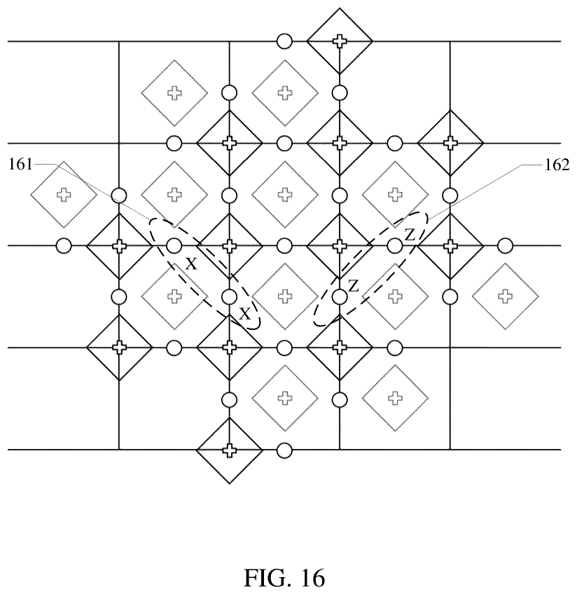

acting on Rᵢ are considered. If an appropriate Rᵢ is selected, decoding performance is greatly affected. Because it is hoped that a quantity of qubits included in Rᵢ is controlled within a specific constant. In addition, Rᵢ may further include all possible local error correlations as much as possible. A most classical error correlation is brought by a syndrome measurement circuit. As shown in FIG. 16, the classical correlation error generated by the syndrome measurement circuit is a two-body X error and a two-body Z error of slash lines. In FIG. 16, a dashed box 161 represents the two-body X error, and a dashed box 162 represents the two-body Z error. Therefore, during division of bit regions R, two types of errors need to be distributed along slashes as far as possible.

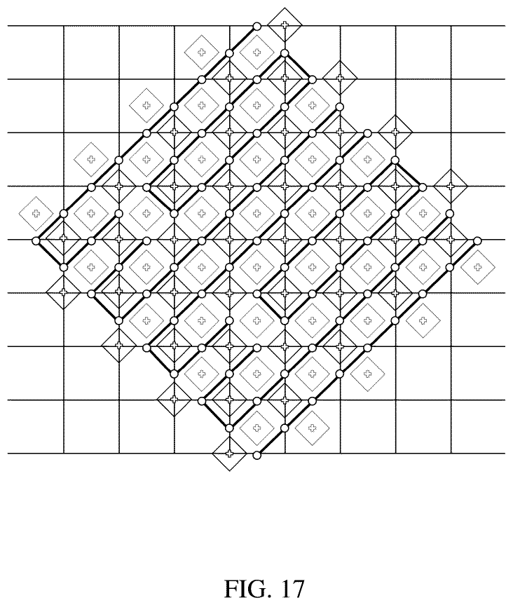

FIG. 17 shows a qubit division manner [symbol] _{R} for a Z error with L=9. In FIG. 17, each small white circle represents a physical qubit, and physical qubits connected to each dark black line belong to the same block. In this way, from bottom to top, a quantity of |Rᵢ| is a Pauli error E^{Z} included in {12,12,12,12,12,12,9} physical qubits. For an X-type error, it is necessary to rotate each divided subset of qubits by 90 degrees.

When the physical qubits in a quantum circuit are divided into blocks, correlation between errors is considered, so that qubits included in the same block are prone to generate correlated errors, which is helpful to further improve decoding performance.

In some embodiments, a qubit included in a sample quantum circuit is divided in a plurality of different block division manners in a process of training the neural network decoder, and jointly training is performed on the neural network decoder based on the plurality of different block division manners. The qubits included in the quantum circuit are divided in one of the plurality of different block division manners during use of the neural network decoder.

When a second-type decoder is considered, and end-to-end training is performed by using an original errors generated in a simulation process, an error floor phenomenon appears in a decoding effect in a low physical error rate range, that is, at a low physical error rate, a logical error become very slow with the decline of the physical errors to loss an original decoding effect of an error correction code.

When the physical error rate is low enough, it is a high-order correlation error that plays a leading role. These errors are difficult to be covered in the same region Rᵢ of [symbol] _{R} simultaneously. Therefore, during decoding, an obtained marginal probability cannot cover these correlations. In addition, it is necessary to control a size of the region R within a specific size range to reduce complexity of an output end. In fact, unless all physical bits are covered, a larger quantity of qubits included in Rᵢ is not preferred. Whether to effectively include possible high-order correlation noise is important. Under the limitation, to reduce an impact of the high-order correlation noise, a variety of divisions are used and cross-validation is performed during training. Specific manners are as follows:
considering t divisions:

$$\begin{matrix}{𝒫}_{R}^{( 1 )} : R = {R}_{1}^{( 1 )} ⊔ {R}_{2}^{( 1 )} … ⊔ {R}_{m}^{( 1 )} \\ {𝒫}_{R}^{( 2 )} : R = {R}_{1}^{( 2 )} ⊔ {R}_{2}^{( 2 )} … ⊔ {R}_{m}^{( 2 )} \\ {𝒫}_{R}^{( f )} : R = {R}_{1}^{( t )} ⊔ {R}_{2}^{( t )} … ⊔ {R}_{m}^{( t )}\end{matrix}$$

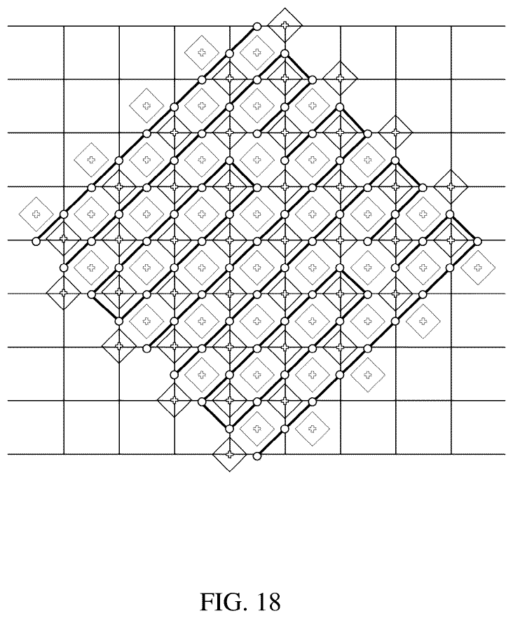

These divisions are to generate maximum differentiation with respecting a difference of correlated noise. FIG. 18 shows another division of a qubit of L=9, which is different from that in FIG. 17.

In a training stage, multi-task networks corresponding to [symbol] . . . [symbol] divisions are placed at a backend of a decoding neural network. In the training stage, jointly training is performed on distribution of regions corresponding to different divisions. Specifically, a total loss function needs to be redefined:

$$Loss = {\sum }_{t , i} {α}_{i}^{t} \cdot {loss}_{i}^{( t )}$$

In addition, a random gradient descent is used for learning. This can achieve cross-validation in the training stage. In other words, an impact on high-order correlation errors is reduced as much as possible in the training stage. Once the training is completed, only one of these divisions is actually used for decoding, for example, [symbol] . In this way, although training complexity is increased, complexity and computation time of the error correction algorithm itself do not change, which is not affect actual decoding delay and engineering deployment. The simulation results show that only t=2 is needed, which can largely reduce the impact on the high-order correlation errors and greatly improve a logical error rate of the error correction algorithm in the low physical error rate range.

In some embodiments, the chip deploying the neural network decoder may use a single-core architecture or a multi-core architecture. The single-core architecture and multi-core architecture here means a quantity of processors (or referred to as processing cores).

For using the single-core architecture, the chip includes a single processor, and all the execution operations of the neural network decoder introduced in the foregoing embodiment are completed by the single processor. As introduced above, computational complexity of the decoding method provided in the present disclosure is O(L³). When L is small, the single-core architecture can bear the computational complexity; but when L is large, the single-core architecture has a limitation. Therefore, the present disclosure proposes a solution with the multi-core architecture.

For using the multi-core architecture, the chip includes a plurality of tree-structured processors. In this embodiment of the present disclosure, the quantity of processors included in the chip is not limited under the multi-core architecture, and a design may be specifically combined with a size of L or computational complexity. The entire decoding algorithm can be completed with full use of a computing power of each processor.

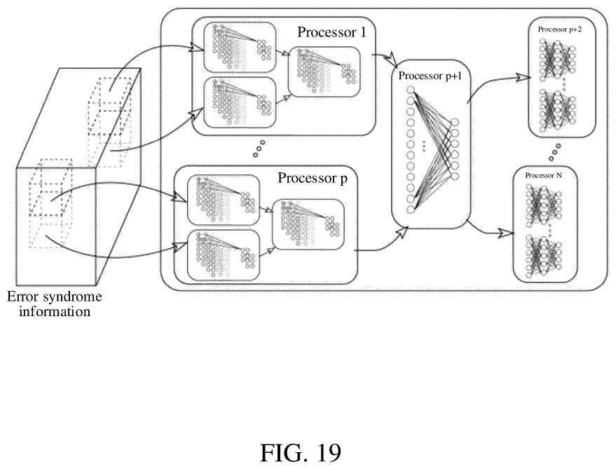

For using the multi-core architecture, any two processors that are not connected have parallelity, which can maximize a computing capability of each processor and shorten decoding time. In addition, any two processors that are connected may execute in sequence. FIG. 19 is a schematic diagram of a multi-core architecture. There may be no connection between processor 1 to processor p, and p processors can execute in parallel, such as using a divide and conquer strategy to perform parallel processing on different blocks in error syndrome information, and/or using LFEM to perform local feature extraction mapping on different input data blocks. The feature data extracted by 1 to processor p is sent to processor p+1. The processor p+1 processes the feature data provided by processor 1 to processor p to obtain feature information. Then, the feature information is inputted to processor p+2 to processor N, respectively. There is no connection relationship between processor p+2 to processor N, and a plurality of processors can execute in parallel. For example, a feature decoding network is deployed on each processor to decode the feature information to obtain a corresponding decoding result. Finally, a specific processor may determine error result information based on decoding results respectively corresponding to the feature decoding networks.

For the plurality of processors executing in parallel, to-be-processed information may be sent to each processor simultaneously, so that the plurality of processors can execute in parallel. For example, for processor 1 to processor p in the foregoing example, the different blocks in the error syndrome information may be sent to each processor simultaneously, so that the p processors can execute in parallel. For another example, for processor P+2 to processor N in the foregoing example, feature information may be sent to each processor simultaneously, so that the plurality of processors can execute in parallel. In some other embodiments, a separate controller or processor may also be set to control execution timing of each processor, for example, control a plurality of processors with parallelity to start execution simultaneously and control serial processors to execute in sequence, so as to better coordinate a work of each processor and ensure correctness and stability of a processing flow.

Because the neural network decoder based on multi-task learning provided in the present disclosure has inherent parallelity in both a feature extraction part and a feature decoding part, to be conveniently distributed to a plurality of different processors for execution. Moreover, inputs of the different processors are almost independent, there is almost no need for processor-to-processor communication, and only a small quantity of processors need to communicate to transmit data. This method may be infinite parallelization. Under full use of each processor, a computation scale may always be expanded by adding more processors to keep O(log L) decoding for delay.

According to simulation experiment, the technical solution provided in the present disclosure can achieve the following improvements.

### 1. Reduce a Quantity of Models to Facilitate Deployment of a Hardware System.

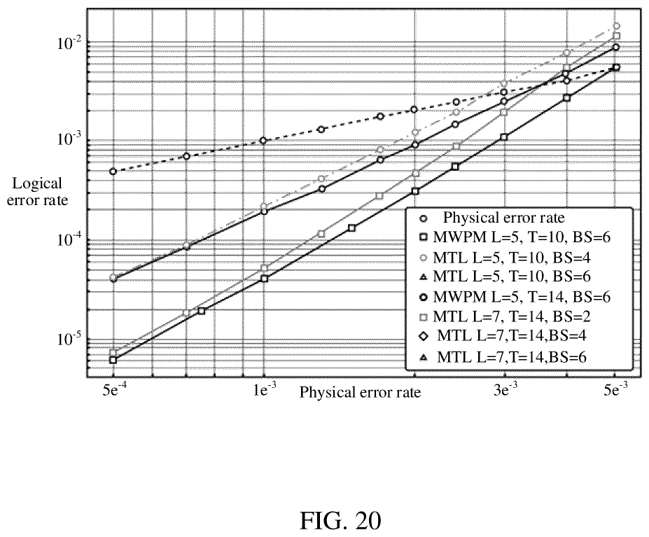

No matter how large an error correction code scale is, two models are used, one is for outputting X-type errors, and the other is for outputting Z-type errors. In consideration of the current computing capability of the FPGA, attention is first paid to a first-type decoder (error canonical decomposition of an output end). A simulation result is as shown in FIG. 20, and after training is performed with indirect training data generated through MWPM, high decoding performance is achieved for different sizes of the subblocks within the output canonical syndromes, based on various partitions. In this case, decoding performance is almost independent of the output canonical syndrome size. In addition, when only two models are used, decoding performance is basically close to that of the MWPM decoder, especially at a low physical error rate. Therefore, a shared frontend of the multi-task learning decoder provided in the present disclosure can indeed capture all feature information needed for high-performance decoding.

In specific, for performance of actual deployment on hardware, research focuses on a case where L=5 (49 data bits and auxiliary bits in total) and 10 rounds of syndrome measurement is performed. An output end is considered to provide three outputs, respectively corresponding to

$${L}_{c}^{X \vert Z}$$

and two canonical syndromes

$${S}_{1}^{X \vert Z} and {S}_{2}^{X \vert Z}$$

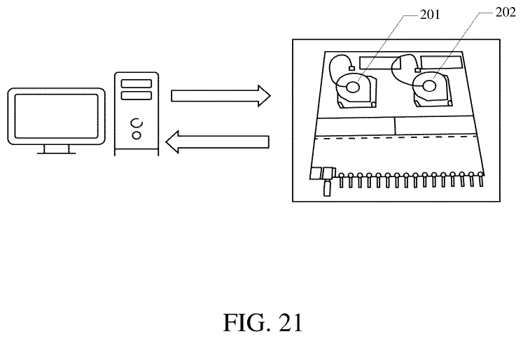

each including 12-bit information. A corresponding model uses 330,000 parameters. After 8-bit unsigned quantization (UINT8) of the model, two networks are deployed on two Intel Stratix 10SX FPGAs, respectively. As shown in FIGS. 21, 201 and 202 in the figure represents two Intel Stratix 10SX FPGAs, which are configured to decode an X-type error and a Z-type error, respectively.

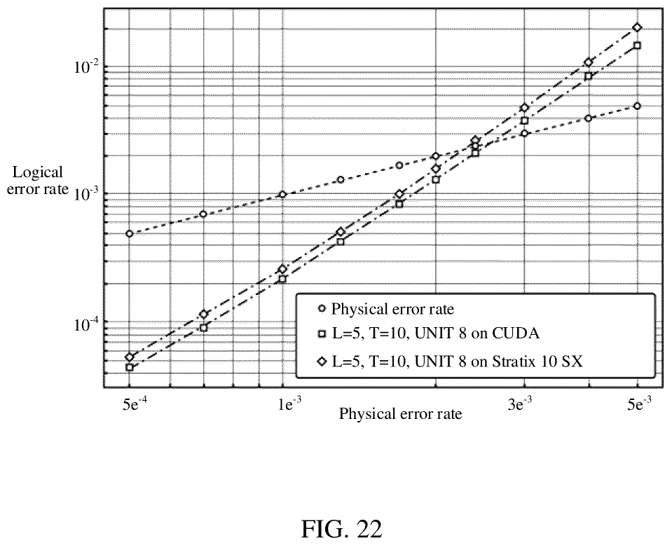

To simulate an entire decoding process, generation of quantum noise is simulated and a syndrome measurement circuit with noise is run on a computer. After 10 rounds of syndrome measurement, syndromes (120 pieces of classical bit information) are divided into X-type syndromes and Z-type syndromes (where there are 60 syndromes of each type), and are then transmitted to two FPGAs through network ports. After the FPGAs complete decoding, the error information obtained from decoding is transmitted to the computer to determine whether the decoding result indicates that the decoding is succeed. After a large-scale Monte Carlo test, the decoding performance of the FPGA is shown in FIG. 22, and the overall decoding delay is 700 ns. A higher-end Intel Stratix 10 SX FPGA is used, and decoding is started upon receipt of a part of syndromes. It takes a total of 280 ns from the receipt of the syndrome to completion of the entire decoding process, which is a known fastest speed record of implementing hardware decoding for 49 bits.

### 2. Greatly Improve Decoding Performance

Using a second-type decoder can greatly improve the decoding performance in the following way:
(1) second-type error decomposition;
(2) using two types of syndromes as outputs of decoding;
(3) dividing output regions based on generation modes of correlated errors; and
(4) using a plurality of different division manners to perform cross-validation of joint learning in a training stage.

The decoder provided in the present disclosure can reduce computational complexity, network complexity, and a computational depth, thereby greatly improving an actual decoding capability.

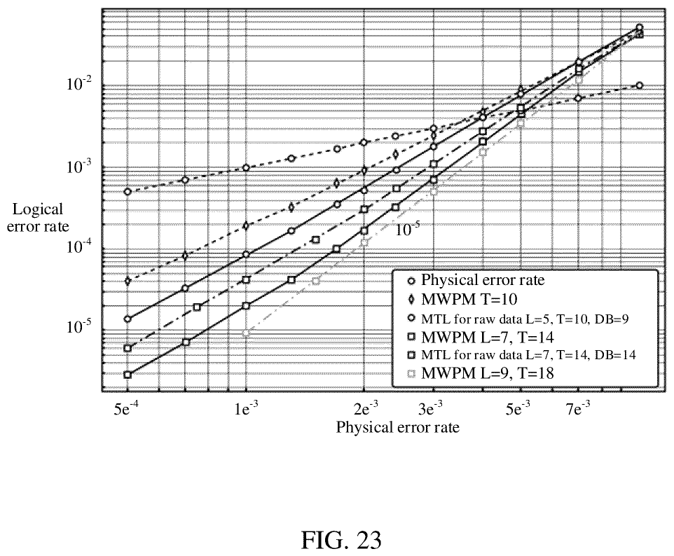

FIG. 23 shows L=5 and L=7 (respectively corresponding to 49 and 97 physical bits, including data and auxiliary bits). In all physical error regions, decoding performance of a second-type decoder is much better than that of MWPM, and a logical error rate of the second-type decoder is less than or equal to ½ of that of MPWM. The second-type decoder is a best fault-tolerant decoder known at present.

Apparatus embodiments of the present disclosure are described below, and may be configured to perform the method embodiments of the present disclosure. For details not disclosed in the apparatus embodiments of the present disclosure, reference is made to the method embodiments of the present disclosure.

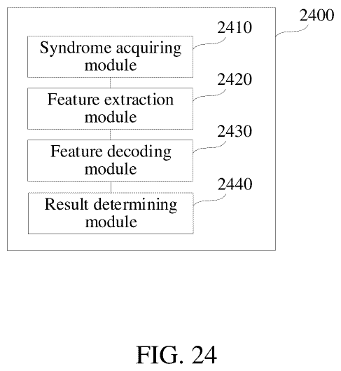

FIG. 24 is a block diagram of a neural network-based quantum error correction decoding apparatus according to an embodiment of the present disclosure. The apparatus has a function of implementing the foregoing method examples, and the function may be implemented by using hardware, or may be implemented by using hardware executing corresponding software. The device may be a computer device, or may be provided in the computer device. The apparatus 2400 may include a syndrome acquiring module 2410, a feature extraction module 2420, a feature decoding module 2430, and a result determining module 2440.

The syndrome acquiring module 2410 is configured to acquire error syndrome information obtained from syndrome measurement performed on a quantum circuit.

The feature extraction module 2420 is configured to use a neural network decoder to extract feature information from the error syndrome information. The neural network decoder includes the feature extraction network and n feature decoding networks, and n is an integer greater than 1.

The feature decoding module 2430 is configured to use the neural network decoder to decode the feature information to obtain a decoding result.

The result determining module 2440 is configured to determine error result information of the quantum circuit based on the decoding result.

In some embodiments, the feature extraction module 2420 is configured to use a feature extraction network of the neural network decoder to perform feature extraction on the error syndrome information to obtain the feature information. The neural network decoder includes the feature extraction network and n feature decoding networks, and n is an integer greater than 1.

The feature decoding module 2430 is configured to use the n feature decoding networks to separately decode the feature information to obtain decoding results respectively corresponding to the n feature decoding networks. The n feature decoding networks are trained in a multi-task learning manner to be enabled to generate different decoding results.

The result determining module 2440 is configured to determine the error result information based on the decoding results respectively corresponding to the n feature decoding networks.

In some embodiments, one or more qubit (or a plurality of qubits) included in the quantum circuit is (or are) divided into n blocks, and each block includes at least one qubit. For a k^{th} feature decoding network of the n feature decoding networks, a decoding result corresponding to the k^{th} feature decoding network includes: a Pauli operator acting on the qubit included in a k^{th} block of the n blocks, where k is a positive integer less than or equal to n.

The result determining module 2440 is configured to determine the error result information based on Pauli operators acting on the n blocks, respectively.

In some embodiments, the error result information indicates a qubit in which a Pauli X error occurs and a qubit in which a Pauli Z error occurs in a quantum circuit.

In some embodiments, division of the blocks is related to correlation between errors, and the qubit included in the same block is prone to correlated errors.

In some embodiments, a qubit included in a sample quantum circuit is divided in a plurality of different block division manners in a process of training the neural network decoder, and jointly training is performed on the neural network decoder based on the plurality of different block division manners. The qubit included in the quantum circuit is divided in one of the plurality of different block division manners during use of the neural network decoder.

In some embodiments, the feature decoding module 2430 is configured to:
use n₁ feature decoding networks to separately decode the feature information to obtain decoding results respectively corresponding to the n₁ feature decoding networks, for an i^{th} feature decoding network of the n₁ feature decoding networks, a decoding result corresponding to the i^{th} feature decoding network including: an i^{th} canonical syndrome related to a target error type, i being a positive integer less than or equal to n₁, and the canonical syndrome being a canonical decomposition result of the error syndrome information; and
use n₂ feature decoding networks to separately decode the feature information to obtain decoding results respectively corresponding to the n₂ feature decoding networks, for a j^{th} feature decoding network of the n₂ feature decoding networks, a decoding result corresponding to the j^{th} feature decoding network including: a fixed representative element related to the target error type, j being a positive integer less than or equal to n₂,
a sum of n₁ and n₂ being equal to n, and both n₁ and n₂ being positive integers.

In some embodiments, the target error type includes the Pauli X error and the Pauli Z error, n₁ is equal to a sum of m₁ and m₂, both m₁ and m₂ are positive integers, and n₂ is equal to 2;
m₁ feature decoding networks of the n₁ feature decoding networks are configured to separately decode the feature information to obtain m₁ canonical syndromes related to the Pauli X error;
m₂ feature decoding networks of the n₁ feature decoding networks are configured to separately decode the feature information to obtain m₂ canonical syndromes related to the Pauli Z error;
one of the n₂ feature decoding networks is configured to decode the feature information to obtain a fixed representative element related to the Pauli X error; and
another one of the n₂ feature decoding networks is configured to decode the feature information to obtain a fixed representative element related to the Pauli Z error.

The result determining module 2440 is configured to:
determine X-type error result information based on the fixed representative element related to the Pauli X error and the m₁ canonical syndromes related to the Pauli X error, the X-type error result information indicating the qubit in which the Pauli X error occurs in the quantum circuit; and
determine Z-type error result information based on the fixed representative element related to the Pauli Z error and the m₂ canonical syndromes related to the Pauli Z error, the Z-type error result information indicating the qubit in which the Pauli Z error occurs in the quantum circuit.

In some embodiments, the feature extraction network includes a plurality of cascaded feature extraction subnetworks, where input data of a first feature extraction subnetwork includes the error syndrome information, input data of an s^{th} feature extraction subnetwork includes output data of an (s−1)^{th} feature extraction subnetwork, output data of a last feature extraction subnetwork includes the feature information, and s is an integer greater than 1;
for a target feature extraction subnetwork of the plurality of cascaded feature extraction subnetworks, input data of the target feature extraction subnetwork is divided into a plurality of input data blocks of a same scale;
the target feature extraction subnetwork is configured to perform a plurality of local feature extraction mappings on the plurality of input data blocks to obtain a plurality of sets of mapping output data, where each local feature extraction mapping is configured to perform mapping on regions at a same location in the plurality of input data blocks to obtain a set of mapping output data; and the plurality of local feature extraction mappings are configured to perform mapping on regions at different locations in the plurality of input data blocks to obtain the plurality of sets of mapping output data; and
the target feature extraction subnetwork is further configured to obtain output data of the target feature extraction subnetwork based on the plurality of sets of mapping output data. In some embodiments, the regions at the different locations overlap each other.

In some embodiments, the target feature extraction subnetwork includes at least one convolutional layer and at least one fully connected layer, where
the at least one convolutional layer is configured to perform the plurality of local feature extraction mappings on the plurality of input data blocks to obtain the plurality of sets of mapping output data, and
the at least one fully connected layer is configured to obtain the output data of the target feature extraction subnetwork based on the plurality of sets of mapping output data.

In some embodiments, a measurement collection process of new error syndrome information is performed in parallel during a process of the neural network decoder decoding the acquired error syndrome information.

In some embodiments, a training process of a neural network decoder is as follows:
acquiring sample error syndrome information and sample error result information corresponding to the sample error syndrome information;
using a to-be-trained neural network decoder to obtain, based on the sample error syndrome information, predicted decoding results respectively corresponding to the n feature decoding networks;
determining, based on the predicted decoding results respectively corresponding to the n feature decoding networks and label decoding results that respectively correspond to the n feature decoding networks and that is determined based on the sample error result information, loss function values respectively corresponding to the n feature decoding networks;
determining a total loss function value based on the loss function values respectively corresponding to the n feature decoding networks; and
adjusting a parameter of the to-be-trained neural network decoder based on the total loss function value to obtain a trained neural network decoder.

In some embodiments, the neural network decoder includes the feature extraction network and the n feature decoding networks that are deployed on the same chip.

In some embodiments, the chip on which the neural network decoder is deployed includes a plurality of tree-structured processors, and any two processors that are not connected are allowed to operate in parallel.

When the apparatus provided in the foregoing embodiment implements functions of the apparatus, division of the foregoing functional modules is merely used as an example for description. In practical application, the foregoing functions may be allocated to different functional modules for implementation based on a requirement. To be specific, an internal structure of a device is divided into different functional modules, to implement all or some of the functions described above. In addition, the apparatus provided in the foregoing embodiments and the method embodiments fall within the same conception. For details of a specific implementation process, reference is made to the method embodiments. Details are not described herein again.

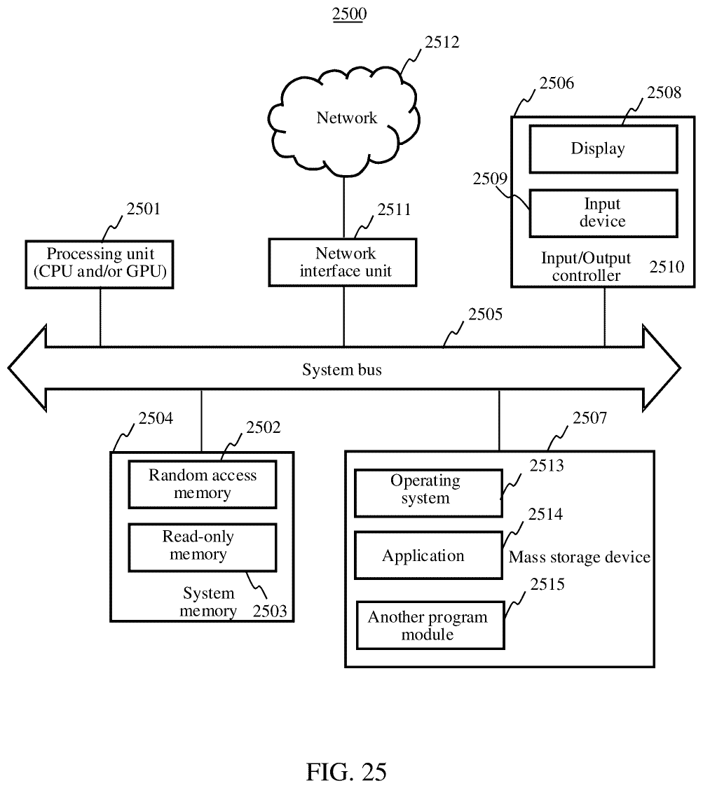

FIG. 25 is a schematic diagram of a structure of a computer device according to an embodiment of the present disclosure. The computer device may be the control device 43 in the application scenario of the solution shown in FIG. 4. The computer device may be configured to implement the neural network-based quantum error correction decoding method according to the foregoing embodiments. Specifically,

the computer device 2500 includes a processing unit 2501 (for example, a CPU and/or a GPU), a system memory 2504 including a random access memory (RAM) 2502 and a read-only memory (ROM) 2503, and a system bus 2505 connecting the system memory 2504 to the processing unit 2501. The computer device 2500 further includes a basic input/output (I/O) system 2506 assisting in transmitting information between components in a computer, and a mass storage device 2507 configured to store an operating system 2513, an application program 2514, and another program module 2515.

The basic input/output system 2506 includes a display 2508 configured to display information and an input device 2509 such as a mouse or a keyboard configured to input information by a user. The display 2508 and the input device 2509 are connected to an input/output controller 2505 of the system bus 2510, to be connected to the processing unit 2501. The basic input/output system 2506 may further include the input/output controller 2510 to be configured to receive and process input from a plurality of other devices such as a keyboard, a mouse, and an electronic stylus.

The mass storage device 2507 is connected to the processing unit 2501 by using a mass storage controller (not shown) connected to the system bus 2505. The mass storage device 2507 and a computer-readable medium associated with the mass storage device provide non-volatile storage to the computer device 2500. In other words, the mass storage device 2507 may include a computer-readable medium (not shown) such as a hard disk or a compact disc ROM (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable read-only memory (EPROM), an electrically erasable programmable read-only memory (EEPROM), a flash memory or another solid-state memory technology, a CD-ROM, a digital video disc (DVD) or another optical memory, a tape cartridge, a magnetic cassette, a magnetic disk memory, or another magnetic storage device. Certainly, a person skilled in the art may know that the computer storage medium is not limited to the foregoing several types. The system memory 2504 and the mass storage device 2507 may be collectively referred to as a memory.

According to embodiments of the present disclosure, the computer device 2500 may further be connected, through a network such as the Internet, to a remote computer on the network to run. To be specific, the computer device 2500 may be connected to a network 2512 by using a network interface unit 2511 connected to the system bus 2505, or may be connected to another type of network or a remote computer system (not shown) by using a network interface unit 2511.

The memory has a computer program stored therein. The computer program is configured to be executed by one or more processors to implement the neural network-based quantum error correction decoding method according to the foregoing embodiments.

In an exemplary embodiment, a computer-readable storage medium is further provided. The computer-readable storage medium has a computer program stored thereon. The computer program, when executed by a computer device, implements the neural network-based quantum error correction decoding method according to the foregoing embodiments. In an exemplary embodiment, the computer-readable storage medium may be a ROM, a RAM, a CD-ROM, a magnetic tape, a floppy disk, an optical data storage device, and the like.

In an exemplary embodiment, a computer program product is further provided. The computer program product, when being executed, is configured to implement neural network-based quantum error correction decoding method according to the foregoing embodiments.

In an exemplary embodiment, a chip is further provided. The chip includes a programmable logic circuit and/or program instructions. The chip runs on a computer device and is configured to implement the neural network-based quantum error correction decoding method according to the foregoing embodiments.

In some embodiments, the chip is an FPGA chip or an ASIC chip.

In various embodiments in the present disclosure, a unit may refer to a software unit, a hardware unit, or a combination thereof. A software unit may include a computer program or part of the computer program that has a predefined function and works together with other related parts to achieve a predefined goal, such as those functions described in this disclosure. A hardware unit may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

What are disclosed above are merely examples of embodiments of the present disclosure, and certainly are not intended to limit the protection scope of the present disclosure. Therefore, equivalent variations made in accordance with the claims of the present disclosure shall fall within the scope of the present disclosure.

What is claimed is:

1. A method for decoding quantum error correction based on a neural network, performed by an electronic device, the method comprising:
acquiring error syndrome information obtained from syndrome measurement performed on a quantum circuit;
extracting feature information from the error syndrome information by using a neural network decoder;
decoding the feature information to obtain a decoding result by using the neural network decoder; and
determining error result information of the quantum circuit based on the decoding result.

2. The method according to claim 1, wherein:
the extracting the feature information from the error syndrome information comprises:
using a feature extraction network of the neural network decoder to perform feature extraction on the error syndrome information to obtain the feature information, the neural network decoder comprising the feature extraction network and n feature decoding networks, and n being an integer greater than 1;
the decoding the feature information to obtain the decoding result comprises:
using the n feature decoding networks of the neural network decoder to separately decode the feature information to obtain decoding results respectively corresponding to the n feature decoding networks, the n feature decoding networks being trained in a multi-task learning manner to be enabled to generate different decoding results; and
the determining the error result information of the quantum circuit based on the decoding result comprises:
determining the error result information based on the decoding results respectively corresponding to the n feature decoding networks.

3. The method according to claim 2, wherein:
a plurality of qubits comprised in the quantum circuit are divided into n blocks, and each block comprises at least one qubit;
for a k^{th} feature decoding network of the n feature decoding networks, a decoding result corresponding to the k^{th} feature decoding network comprises: a Pauli operator acting on a qubit comprised in a k^{th} block of the n blocks, wherein k is a positive integer less than or equal to n; and
the determining the error result information based on the decoding results respectively corresponding to the n feature decoding networks comprises:
determining the error result information based on Pauli operators acting on the n blocks, respectively.

4. The method according to claim 3, wherein the error result information indicates a qubit in which a Pauli X error occurs and a qubit in which a Pauli Z error occurs in the quantum circuit.

5. The method according to claim 2, wherein the using the n feature decoding networks of the neural network decoder to separately decode the feature information to obtain the decoding results respectively corresponding to the n feature decoding networks comprises:
using n₁ feature decoding networks within the n feature decoding networks to separately decode the feature information to obtain decoding results respectively corresponding to the n₁ feature decoding networks, for an i^{th} feature decoding network of the n₁ feature decoding networks, a decoding result corresponding to the i^{th} feature decoding network comprising: an i^{th} canonical syndrome related to a target error type, i being a positive integer less than or equal to n₁, and the canonical syndrome being a canonical decomposition result of the error syndrome information; and
using n₂ feature decoding networks within the n feature decoding networks to separately decode the feature information to obtain decoding results respectively corresponding to the n₂ feature decoding networks, for a j^{th} feature decoding network of the n₂ feature decoding networks, a decoding result corresponding to the j^{th} feature decoding network comprising: a fixed representative element related to the target error type, j being a positive integer less than or equal to n₂,
wherein a sum of n₁ and n₂ is equal to n, and both n₁ and n₂ are positive integers.

6. The method according to claim 5, wherein:
the target error type comprises a Pauli X error and a Pauli Z error;
a sum of m₁ and m₂ is equal to n₁, and both m₁ and m₂ are positive integers;
m₁ feature decoding networks of the n₁ feature decoding networks are configured to separately decode the feature information to obtain m₁ canonical syndromes related to the Pauli X error;
m₂ feature decoding networks of the n₁ feature decoding networks are configured to separately decode the feature information to obtain m₂ canonical syndromes related to the Pauli Z error;
n₂ is equal to 2;
one of the n₂ feature decoding networks is configured to decode the feature information to obtain a fixed representative element related to the Pauli X error;
another one of the n₂ feature decoding networks is configured to decode the feature information to obtain a fixed representative element related to the Pauli Z error; and
the determining the error result information based on the decoding results respectively corresponding to the n feature decoding networks comprises:
determining X-type error result information based on the fixed representative element related to the Pauli X error and the m₁ canonical syndromes related to the Pauli X error, the X-type error result information indicating a qubit in which the Pauli X error occurs in the quantum circuit; and
determining Z-type error result information based on the fixed representative element related to the Pauli Z error and the m₂ canonical syndromes related to the Pauli Z error, the Z-type error result information indicating a qubit in which the Pauli Z error occurs in the quantum circuit.

7. The method according to claim 2, wherein:
the feature extraction network of the neural network decoder comprises a plurality of cascaded feature extraction subnetworks, wherein input data of a first feature extraction subnetwork comprises the error syndrome information, input data of an s^{th} feature extraction subnetwork comprises output data of an (s−1)^{th} feature extraction subnetwork, output data of a last feature extraction subnetwork comprises the feature information, and s is an integer greater than 1;
for a target feature extraction subnetwork of the plurality of cascaded feature extraction subnetworks, input data of the target feature extraction subnetwork is divided into a plurality of input data blocks of a same scale;
the target feature extraction subnetwork is configured to perform a plurality of local feature extraction mappings on the plurality of input data blocks to obtain a plurality of sets of mapping output data, wherein each local feature extraction mapping is configured to perform mapping on regions at a same location in the plurality of input data blocks to obtain a set of mapping output data; and the plurality of local feature extraction mappings are configured to perform mapping on regions at different locations in the plurality of input data blocks to obtain the plurality of sets of mapping output data; and
the target feature extraction subnetwork is further configured to obtain output data of the target feature extraction subnetwork based on the plurality of sets of mapping output data.

8. The method according to claim 2, wherein:
the feature extraction network and the n feature decoding networks comprised in the neural network decoder are deployed on a same chip.

9. The method according to claim 1, further comprising:
training the neural network decoder by:
acquiring sample error syndrome information and sample error result information corresponding to the sample error syndrome information;
using a to-be-trained neural network decoder to obtain, based on the sample error syndrome information, predicted decoding results respectively corresponding to the n feature decoding networks;
determining, based on the predicted decoding results respectively corresponding to the n feature decoding networks and label decoding results that respectively correspond to the n feature decoding networks and that is determined based on the sample error result information, loss function values respectively corresponding to the n feature decoding networks;
determining a total loss function value based on the loss function values respectively corresponding to the n feature decoding networks; and
adjusting a parameter of the to-be-trained neural network decoder based on the total loss function value to obtain the trained neural network decoder.

10. An apparatus for decoding quantum error correction based on a neural network, the apparatus comprising:
a memory storing instructions; and
a processor in communication with the memory, wherein, when the processor executes the instructions, the processor is configured to cause the apparatus to perform:
acquiring error syndrome information obtained from syndrome measurement performed on a quantum circuit;
extracting feature information from the error syndrome information by using a neural network decoder;
decoding the feature information to obtain a decoding result by using the neural network decoder; and
determining error result information of the quantum circuit based on the decoding result.

11. The apparatus according to claim 10, wherein:
when the processor is configured to cause the apparatus to perform extracting the feature information from the error syndrome information, the processor is configured to cause the apparatus to perform:
using a feature extraction network of the neural network decoder to perform feature extraction on the error syndrome information to obtain the feature information, the neural network decoder comprising the feature extraction network and n feature decoding networks, and n being an integer greater than 1;
when the processor is configured to cause the apparatus to perform decoding the feature information to obtain the decoding result, the processor is configured to cause the apparatus to perform:
using the n feature decoding networks of the neural network decoder to separately decode the feature information to obtain decoding results respectively corresponding to the n feature decoding networks, the n feature decoding networks being trained in a multi-task learning manner to be enabled to generate different decoding results; and
when the processor is configured to cause the apparatus to perform determining the error result information of the quantum circuit based on the decoding result, the processor is configured to cause the apparatus to perform:
determining the error result information based on the decoding results respectively corresponding to the n feature decoding networks.

12. The apparatus according to claim 11, wherein:
a plurality of qubits comprised in the quantum circuit are divided into n blocks, and each block comprises at least one qubit;
for a k^{th} feature decoding network of the n feature decoding networks, a decoding result corresponding to the k^{th} feature decoding network comprises: a Pauli operator acting on a qubit comprised in a k^{th} block of the n blocks, wherein k is a positive integer less than or equal to n; and
when the processor is configured to cause the apparatus to perform determining the error result information based on the decoding results respectively corresponding to the n feature decoding networks, the processor is configured to cause the apparatus to perform:
determining the error result information based on Pauli operators acting on the n blocks, respectively.

13. The apparatus according to claim 12, wherein:
the error result information indicates a qubit in which a Pauli X error occurs and a qubit in which a Pauli Z error occurs in the quantum circuit.

14. The apparatus according to claim 11, wherein, when the processor is configured to cause the apparatus to perform using the n feature decoding networks of the neural network decoder to separately decode the feature information to obtain the decoding results respectively corresponding to the n feature decoding networks, the processor is configured to cause the apparatus to perform:
using n₁ feature decoding networks within the n feature decoding networks to separately decode the feature information to obtain decoding results respectively corresponding to the n₁ feature decoding networks, for an i^{th} feature decoding network of the n₁ feature decoding networks, a decoding result corresponding to the i^{th} feature decoding network comprising: an i^{th} canonical syndrome related to a target error type, i being a positive integer less than or equal to n₁, and the canonical syndrome being a canonical decomposition result of the error syndrome information; and
using n₂ feature decoding networks within the n feature decoding networks to separately decode the feature information to obtain decoding results respectively corresponding to the n₂ feature decoding networks, for a j^{th} feature decoding network of the n₂ feature decoding networks, a decoding result corresponding to the j^{th} feature decoding network comprising: a fixed representative element related to the target error type, j being a positive integer less than or equal to n₂,
wherein a sum of n₁ and n₂ is equal to n, and both n₁ and n₂ are positive integers.

15. The apparatus according to claim 14, wherein:
the target error type comprises a Pauli X error and a Pauli Z error;
a sum of m₁ and m₂ is equal to n₁, and both m₁ and m₂ are positive integers;
m₁ feature decoding networks of the n₁ feature decoding networks are configured to separately decode the feature information to obtain m₁ canonical syndromes related to the Pauli X error;
m₂ feature decoding networks of the n₁ feature decoding networks are configured to separately decode the feature information to obtain m₂ canonical syndromes related to the Pauli Z error;
n₂ is equal to 2;
one of the n₂ feature decoding networks is configured to decode the feature information to obtain a fixed representative element related to the Pauli X error;
another one of the n₂ feature decoding networks is configured to decode the feature information to obtain a fixed representative element related to the Pauli Z error; and
when the processor is configured to cause the apparatus to perform determining the error result information based on the decoding results respectively corresponding to the n feature decoding networks, the processor is configured to cause the apparatus to perform:
determining X-type error result information based on the fixed representative element related to the Pauli X error and the m₁ canonical syndromes related to the Pauli X error, the X-type error result information indicating a qubit in which the Pauli X error occurs in the quantum circuit; and
determining Z-type error result information based on the fixed representative element related to the Pauli Z error and the m₂ canonical syndromes related to the Pauli Z error, the Z-type error result information indicating a qubit in which the Pauli Z error occurs in the quantum circuit.

16. The apparatus according to claim 11, wherein:
the feature extraction network of the neural network decoder comprises a plurality of cascaded feature extraction subnetworks, wherein input data of a first feature extraction subnetwork comprises the error syndrome information, input data of an s^{th} feature extraction subnetwork comprises output data of an (s−1)^{th} feature extraction subnetwork, output data of a last feature extraction subnetwork comprises the feature information, and s is an integer greater than 1;
for a target feature extraction subnetwork of the plurality of cascaded feature extraction subnetworks, input data of the target feature extraction subnetwork is divided into a plurality of input data blocks of a same scale;
the target feature extraction subnetwork is configured to perform a plurality of local feature extraction mappings on the plurality of input data blocks to obtain a plurality of sets of mapping output data, wherein each local feature extraction mapping is configured to perform mapping on regions at a same location in the plurality of input data blocks to obtain a set of mapping output data; and the plurality of local feature extraction mappings are configured to perform mapping on regions at different locations in the plurality of input data blocks to obtain the plurality of sets of mapping output data; and
the target feature extraction subnetwork is further configured to obtain output data of the target feature extraction subnetwork based on the plurality of sets of mapping output data.

17. The apparatus according to claim 11, wherein:
the feature extraction network and the n feature decoding networks comprised in the neural network decoder are deployed on a same chip.

18. The apparatus according to claim 10, wherein, when the processor executes the instructions, the processor is further configured to cause the apparatus to perform:
training the neural network decoder by:
acquiring sample error syndrome information and sample error result information corresponding to the sample error syndrome information;
using a to-be-trained neural network decoder to obtain, based on the sample error syndrome information, predicted decoding results respectively corresponding to the n feature decoding networks;
determining, based on the predicted decoding results respectively corresponding to the n feature decoding networks and label decoding results that respectively correspond to the n feature decoding networks and that is determined based on the sample error result information, loss function values respectively corresponding to the n feature decoding networks;
determining a total loss function value based on the loss function values respectively corresponding to the n feature decoding networks; and
adjusting a parameter of the to-be-trained neural network decoder based on the total loss function value to obtain the trained neural network decoder.

19. A non-transitory computer-readable storage medium, storing computer-readable instructions, wherein, the computer-readable instructions, when executed by a processor, are configured to cause the processor to perform:
acquiring error syndrome information obtained from syndrome measurement performed on a quantum circuit;
extracting feature information from the error syndrome information by using a neural network decoder;
decoding the feature information to obtain a decoding result by using the neural network decoder; and
determining error result information of the quantum circuit based on the decoding result.

20. The non-transitory computer-readable storage medium according to claim 19, wherein:
when the computer-readable instructions are configured to cause the processor to perform extracting the feature information from the error syndrome information, the computer-readable instructions are configured to cause the processor to perform:
using a feature extraction network of the neural network decoder to perform feature extraction on the error syndrome information to obtain the feature information, the neural network decoder comprising the feature extraction network and n feature decoding networks, and n being an integer greater than 1;
when the computer-readable instructions are configured to cause the processor to perform decoding the feature information to obtain the decoding result, the computer-readable instructions are configured to cause the processor to perform:
using the n feature decoding networks of the neural network decoder to separately decode the feature information to obtain decoding results respectively corresponding to the n feature decoding networks, the n feature decoding networks being trained in a multi-task learning manner to be enabled to generate different decoding results; and
when the computer-readable instructions are configured to cause the processor to perform determining the error result information of the quantum circuit based on the decoding result, the computer-readable instructions are configured to cause the processor to perform:
determining the error result information based on the decoding results respectively corresponding to the n feature decoding networks.
